(19) United States
(12) Patent Application Publication
(10) Pub. No.: US 2013/0120796 A1
(43) Pub. Date: May 16, 2013

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Satoki Watariuchi, Tokyo (JP)

(73) Assignee: CANON KABUSHIKI KAISHA, Tokyo (JP)

(21) Appl. No.: 13/674,267

(22) Filed: Nov. 12, 2012

(30) Foreign Application Priority Data
Nov. 15, 2011 (JP) 2011-249859

(51) Int. Cl. G06K 15/02

(52) U.S. Cl. CPC G06K 15/02
USPC 358/1.15

(57) ABSTRACT

An information processing apparatus issues information for identifying a printing apparatus, determines, based on the information, whether printing is to be performed by the printing apparatus, and transmits a print target image to the printing apparatus based on a result of the determination.

### BACKGROUND OF THE INVENTION

1. Field of the Invention

The claimed invention generally relates to information processing and, more particularly, to an information processing apparatus, an information processing method, and a storage medium.

2. Description of the Related Art

It is conventionally known that an electronic mail (hereinafter, referred to as an e-mail) can be used to transmit electronic data (e.g., an image) to be printed. A conventional technique discussed in Japanese Patent Application Laid-Open No. 2009-184292 includes attaching electronic data (e.g., an image to be printed) to an e-mail and transmitting the e-mail to a printing apparatus that has an electronic mail address (hereinafter, referred to as an e-mail address). In this case, the e-mail is transmitted to the printing apparatus via an information processing apparatus (e.g., an e-mail server). The printing apparatus performs printing based on the received electronic data.

The e-mail address is functionally usable as information necessary to identify each printing apparatus. According to the technique discussed in Japanese Patent Application Laid-Open No. 2009-184292, if the e-mail address is informed beforehand to a user who wants to operate the printing apparatus, the user can print an intended image by transmitting an e-mail including the attached image to the e-mail address of the printing apparatus.

However, according to the technique discussed in Japanese Patent Application Laid-Open No. 2009-184292, if a user is once informed of the information usable to identify the printing apparatus, the user can operate the printing apparatus unrestrictedly. In this situation, it is difficult to set a usage condition, such as “printable only ten times.”

### SUMMARY OF THE INVENTION

The claimed invention is directed to an information processing apparatus.

According to an aspect of the claimed invention, an information processing apparatus has at least one processor that executes a program. The information processing apparatus includes a receiving unit configured to receive an issuance request of information for identifying a printing apparatus configured to print an image, a processing unit configured to associate the information with the printing apparatus and to issue the information associated with the printing apparatus if the issuance request is received by the receiving unit, a determining unit configured to receive an image from an external apparatus together with the information issued by the processing unit and to determine, based on the received information, whether the received image is to be printed by the printing apparatus that is identified by the received information, and a transmitting unit configured to transmit the image received by the determining unit to the printing apparatus identified by the information if the determining unit determines that the image is to be printed by the printing apparatus.

According to an exemplary embodiment of the claimed invention, an information processing apparatus can prevent a printing apparatus from performing print processing unrestrictedly.

Further features and aspects of the claimed invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the claimed invention and, together with the description, serve to explain the principles of the claimed invention.

FIG. 1 is a block diagram illustrating an example of a configuration of a printing system according to a first exemplary embodiment of the claimed invention.

FIG. 2 is a sequence diagram illustrating an example of processing that can be performed by the printing system according to the first exemplary embodiment.

FIG. 3 is a flowchart illustrating an example of processing that can be performed by an image forming apparatus according to the first exemplary embodiment.

FIG. 4 is a flowchart illustrating an example of processing that can be performed by the image forming apparatus according to the first exemplary embodiment.

FIG. 5 is a flowchart illustrating an example of processing that can be performed by a mobile according to the first exemplary embodiment.

FIG. 6 is a flowchart illustrating an example of processing that can be performed by the mobile according to the first exemplary embodiment.

FIG. 7 is a flowchart illustrating an example of processing that can be performed by a server according to the first exemplary embodiment.

FIG. 8 illustrates an example of an e-mail address management table, which can be referred to by the server, according to the first exemplary embodiment.

FIG. 9 is a flowchart illustrating an example of processing that can be performed by the server according to the first exemplary embodiment.

FIG. 10 is a flowchart illustrating an example of processing that can be performed by a server according to a second exemplary embodiment of the claimed invention.

FIG. 11 illustrates an example of an e-mail management table, which can be referred to by the server, according to the second exemplary embodiment of the claimed invention.

FIGS. 12A and 12B illustrate examples of an e-mail transmitted by the server according to the second exemplary embodiment.

FIG. 13 is a flowchart illustrating an example of processing that can be performed by the server according to the second exemplary embodiment.

FIG. 14 is a flowchart illustrating an example of processing that can be performed by the server according to the second exemplary embodiment.

FIG. 15 illustrates an example of an e-mail transmitted by the server according to the second exemplary embodiment.

FIG. 16 is a flowchart illustrating an example of processing that can be performed by the server according to the second exemplary embodiment.

FIG. 17 is a flowchart illustrating an example of processing that can be performed by the server according to the second exemplary embodiment.

FIG. 18 illustrates an example of an e-mail that can be transmitted by the server according to the second exemplary embodiment.

FIG. 19 is a flowchart illustrating an example of processing that can be performed by the server according to the second exemplary embodiment.

FIG. 20 is a flowchart illustrating an example of processing that can be performed by the server according to the second exemplary embodiment.

FIG. 21 illustrates an example of the e-mail that can be transmitted by the server according to the second exemplary embodiment.

FIG. 22 is a flowchart illustrating an example of processing that can be performed by the server according to the second exemplary embodiment.

FIG. 23 is a flowchart illustrating an example of processing that can be performed by a server according to a third exemplary embodiment of the claimed invention.

FIGS. 24A and 24B illustrate examples of an e-mail transmitted by the server according to the third exemplary embodiment.

FIG. 25 is a block diagram illustrating an example of a configuration of the server according to the first exemplary embodiment.

### DESCRIPTION OF THE EMBODIMENTS

Various exemplary embodiments, features, and aspects of the claimed invention will be described in detail below with reference to the drawings.

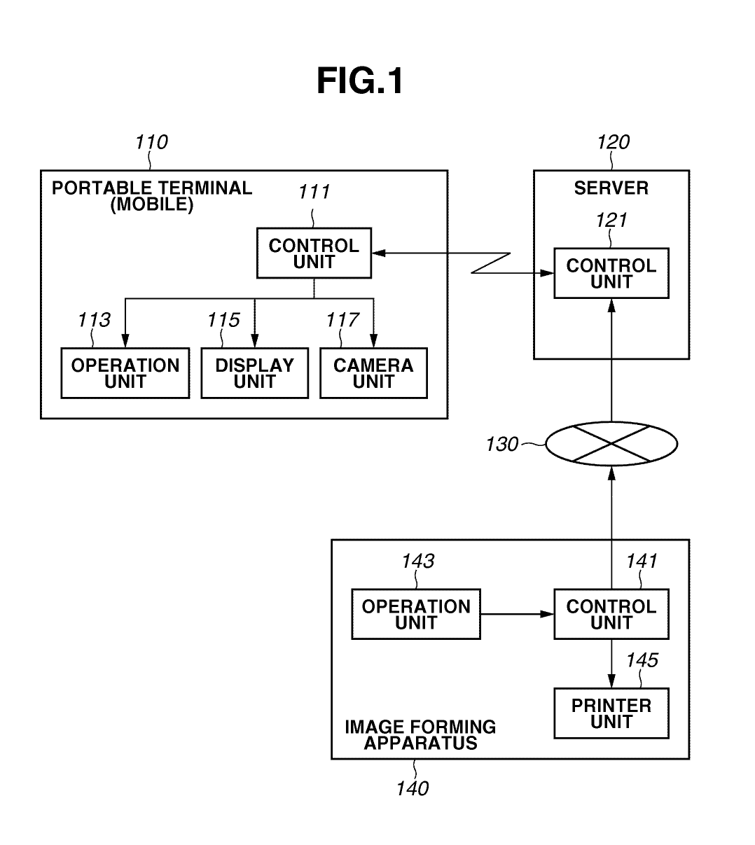

FIG. 1 is a block diagram illustrating an example of a configuration of a printing system according to the present exemplary embodiment.

The printing system includes a portable terminal 110 and a server 120 (i.e., an information processing apparatus) that can transmit and receive an electronic mail (hereinafter, referred to as an e-mail) to communicate with each other. Further, the server 120 is connected to, and can communicate with, an image forming apparatus 140 (i.e., a printing apparatus) via a network (e.g., a wide area network (WAN) 130).

In the present exemplary embodiment, the communication between the portable terminal 110 and the server 120 can be directly performed through a local area network (LAN) or can be indirectly performed via at least one server, such as a server dedicated to a portable terminal base station. Further, the connection between the server 120 and the image forming apparatus 140 is not limited to the WAN 130. Therefore, the WAN 130 can be replaced by a LAN or any other appropriate communication medium.

The portable terminal (hereinafter, referred to as a mobile) 110 includes a control unit 111, an operation unit 113, a display unit 115, and a camera unit 117. The control unit 111 is connected to each of the operation unit 113, the display unit 115, and the camera unit 117.

The control unit 111 includes a central processing unit (CPU), a read only memory (ROM), a random access memory (RAM), and a flash memory. These components (i.e., CPU, ROM, RAM, and flash memory) are cooperatively operable to realize each processing to be performed by the control unit 111. The ROM stores a control program usable for the control unit 111 to control operations of the operation unit 113, the display unit 115, and the camera unit 117. Further, the ROM stores a program usable for the mobile 110 to transmit and receive e-mails to and from the server 120.

The CPU can analyze and execute each control program, if it is loaded into the RAM from the ROM, to control operations to be performed by the operation unit 113, the display unit 115, and the camera unit 117. Further, the CPU can analyze and execute an e-mail transmission and reception program, if it is loaded into the RAM from the flash memory, to transmit and receive e-mails.

If a user instructs transmitting an e-mail via the operation unit 113, the control unit 111 can create and transmit an e-mail including an electronic file (hereinafter, simply referred to as a file), i.e., an image stored in the flash memory, which has been attached according to the user's instruction. If an e-mail is received from the server 120, the control unit 111 can control the display unit 115 to display contents of the received e-mail on the display unit 115. Further, the control unit 111 can control the camera unit 117 in such a way as to perform a photographing operation or to read a QR code (trademark).

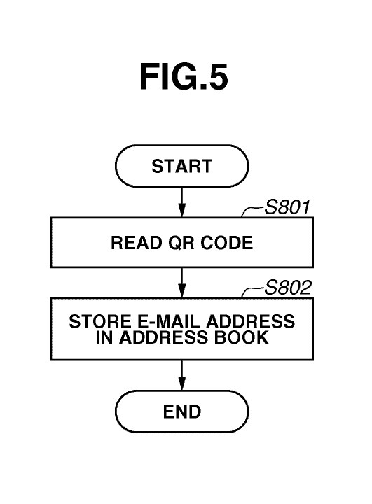

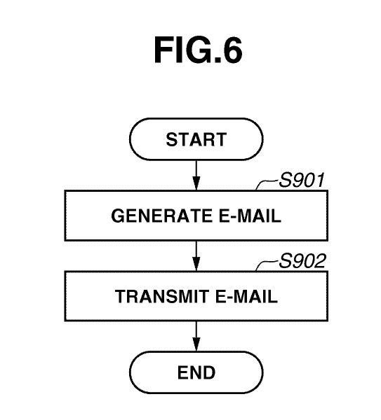

The flash memory stores a program usable to execute processing of flowcharts illustrated in FIGS. 5 and 6. The CPU can analyze and execute the program, if it is loaded into the RAM from the flash memory, so that the mobile 110 can perform various processing.

The server 120 includes a control unit 121 that can control various operations to be performed by the server 120. Further, the server 120 is connected to the image forming apparatus 140 via the WAN 130 to perform file transmission and reception processing.

The control unit 121 includes a CPU, a RAM, a ROM, and a hard disk drive (HDD), although they are not illustrated. These components (i.e., CPU, RAM, ROM, and HDD) are cooperatively operable to realize each processing to be performed by the control unit 121. The ROM stores control programs usable to control operations to be performed by the server 120. The CPU can analyze and execute each control program, when it is loaded into the RAM, so that the control unit 121 can control various operations to be performed by the server 120.

The HDD stores an e-mail transmission and reception program to transmit and receive e-mails to and from the mobile 110. The CPU can analyze and execute the e-mail transmission and reception program, if it is loaded into the RAM, so that the server 120 can transmit and receive e-mails to and from the mobile 110.

Further, the HDD stores a file transmission and reception program that is usable to transmit and receive files to and from the image forming apparatus 140 and an image processing program that is usable to perform image processing on a received file. The CPU can analyze and execute the file transmission and reception program, if it is loaded into the RAM, so that the server 120 can transmit and receive files to and from the image forming apparatus 140. The CPU can analyze and execute the image processing program, if it is loaded into the RAM, so that the server 120 can perform image processing on the received file.

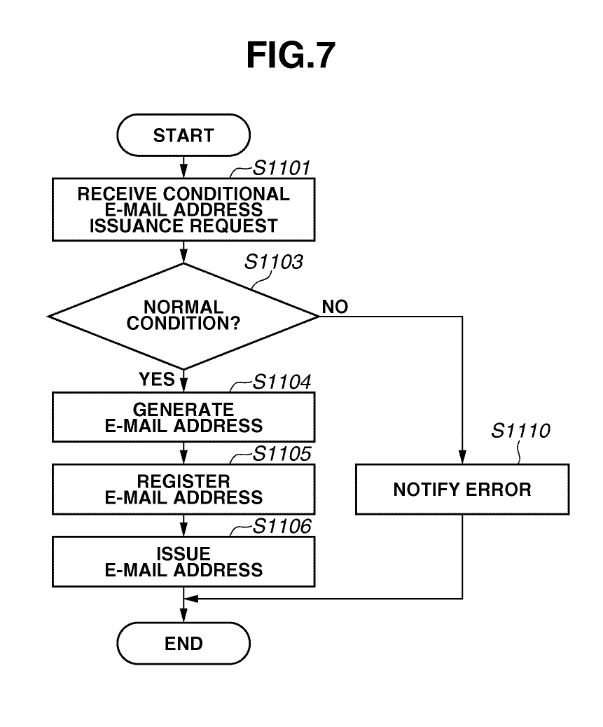

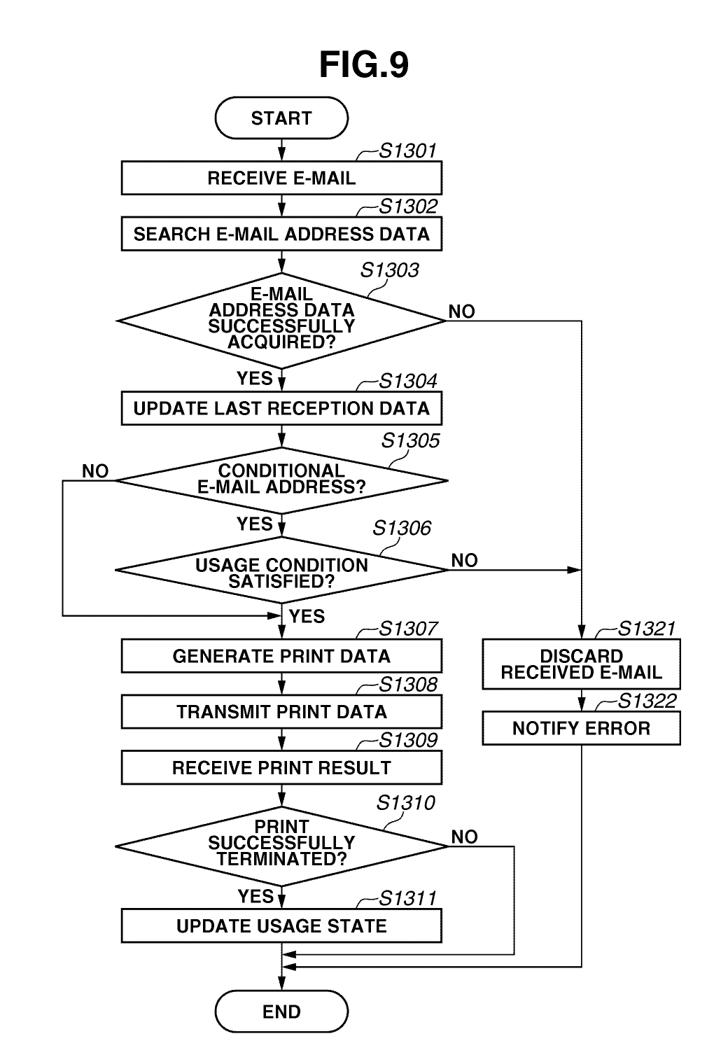

Further, the HDD stores an image processing program that is usable to realize the processing of flowcharts illustrated in FIGS. 7 and 9. The CPU can analyze and execute the image processing program, if it is loaded into the RAM, so that the server 120 can perform various processing.

The image forming apparatus 140 includes a control unit 141 that can control various operations to be performed by the image forming apparatus 140, an operation unit 143 serving as a user interface (UI), and a printer unit 145 serving as an image output device.

The control unit 141 includes a CPU, a RAM, a ROM, and a HDD, although they are not illustrated. These components (i.e., CPU, RAM, ROM, and HDD) are cooperatively operable to realize each processing to be performed by the control unit 141. Further, the control unit 141 is electrically connected to the printer unit 145. On the other hand, the control unit 141 is connected to the server 120 or an external apparatus via the WAN 130. Thus, the control unit 141 can input and output image files and device information from and to the server 120.

The CPU can control an access to each device currently connected to the control unit 141 based on the control program stored in the ROM, and can control various processing to be performed in the control unit 141.

The RAM is usable as a system work memory when the CPU operates and is usable as a memory capable of temporarily storing image data. The RAM is constituted by a nonvolatile static random access memory (SRAM) that can hold stored contents even after the electric power source is turned off and a dynamic random access memory (DRAM) that deletes stored contents when the electric power source is turned off. The ROM stores a boot program of the apparatus.

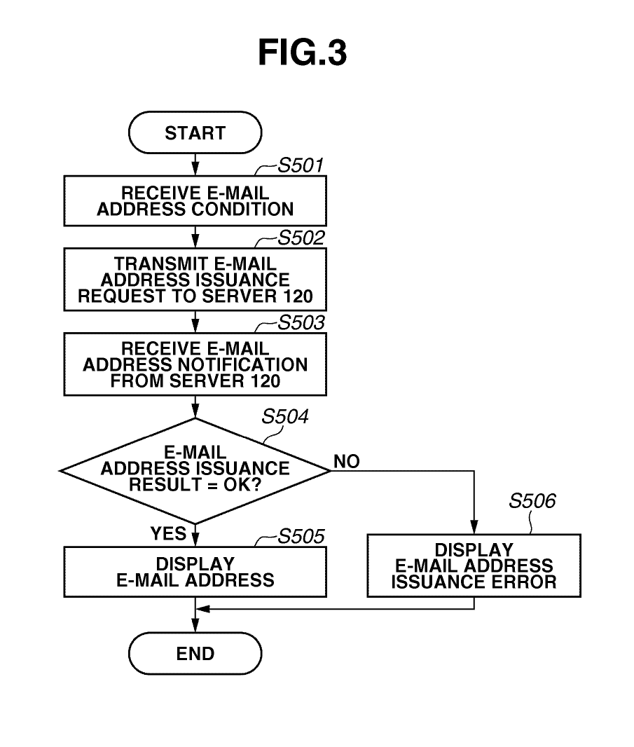

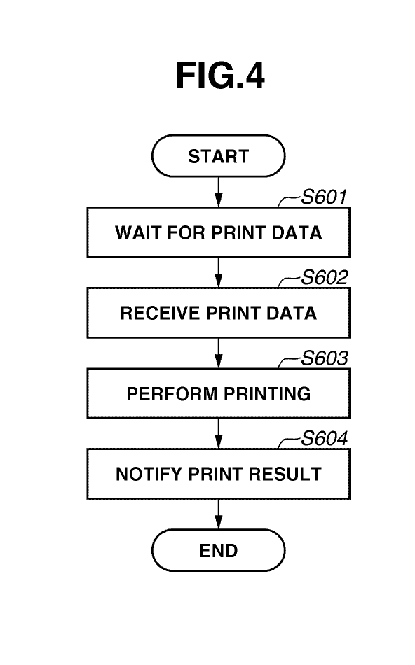

The HDD (i.e., hard disk drive) can store system software and image data. The HDD stores a program usable to execute processing of flowcharts illustrated in FIGS. 3 and 4. The CPU can analyze and execute the program, if it is loaded into the RAM, so that the image forming apparatus 140 can perform various processing.

The control unit 141 is connected to the operation unit 143. The control unit 141 can transmit image data to be displayed on the operation unit 143 to the operation unit 143. Further, the control unit 141 can receive information input by the user via the operation unit 143.

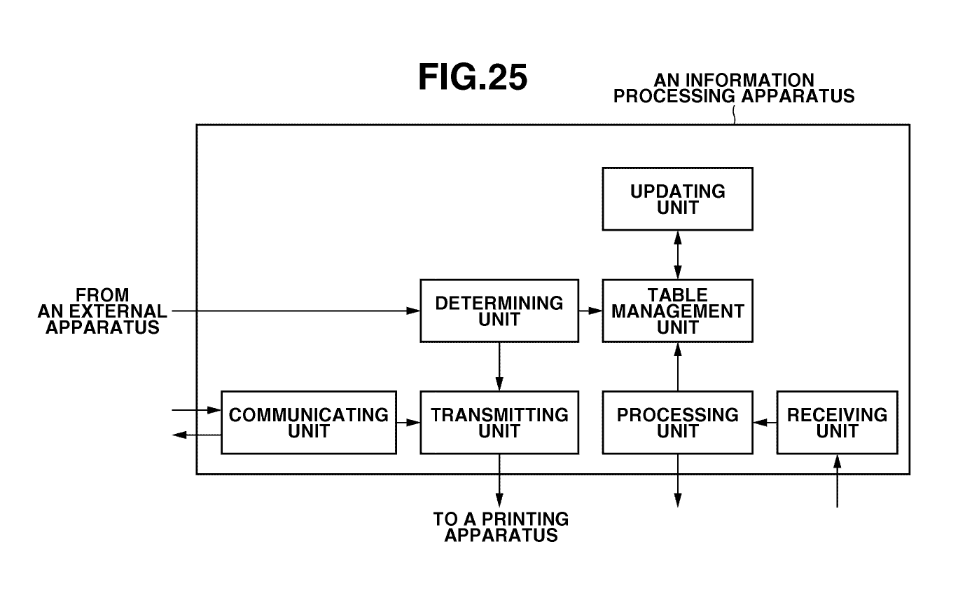

The details described above regarding the configuration of the printing system illustrated in FIG. 1 functionally interact in a manner corresponding to various units. For example, the configuration of the printing system of FIG. 1 may functionally operate as an information processing apparatus including a receiving unit, a processing unit, a determining unit, a transmitting unit, a communicating unit, an updating unit, and a table management unit as illustrated in FIG. 25.

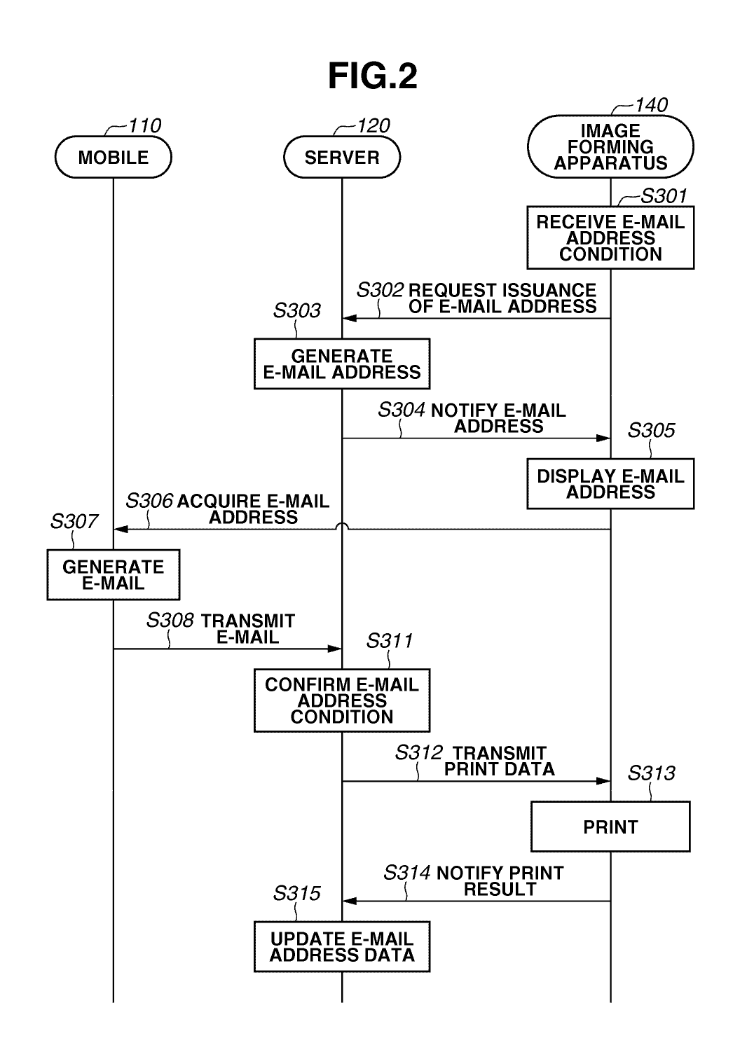

Next, schematic processing that can be performed by the printing system according to the present exemplary embodiment is described below with reference to FIG. 2. FIG. 2 is a sequence diagram illustrating an example of the processing that can be performed by the printing system according to the present exemplary embodiment.

In step S301, the image forming apparatus 140 receives a usage condition relating to an electronic mail address (hereinafter, referred to as an e-mail address) if it is input by a user. Next, in step S302, the image forming apparatus 140 requests the server 120 to issue the e-mail address. The processing performed in steps S301 and S302 corresponds to processing to be performed in steps S501 and S502 illustrated in FIG. 3.

If the server 120 receives such e-mail address issuance request from the image forming apparatus 140, then in step S303, the server 120 generates the e-mail address. Further, in step S304, the server 120 notifies the image forming apparatus 140 of the generated e-mail address. The processing performed in steps S303 and S304 corresponds to sequential processing illustrated in FIG. 7.

If the image forming apparatus 140 receives such e-mail address notification from the server 120, then in step S305, the image forming apparatus 140 causes the operation unit 143 to display a QR code (trademark) that represents the e-mail address notified by the server 120. The processing performed in step S305 corresponds to sequential processing to be performed in steps S503 to S506 illustrated in FIG. 3.

In step S306, the mobile 110 captures an image of the QR code (trademark) displayed on the operation unit 143 of the image forming apparatus 140 with the camera unit 117 and reads the QR code (trademark) to acquire the e-mail address. The processing performed in step S306 corresponds to sequential processing illustrated in FIG. 5.

In step S307, the mobile 110 generates an e-mail to which image data to be printed is attached. Then, in step S308, the mobile 110 transmits the generated e-mail to the server 120. The processing performed in steps S307 and S308 corresponds to sequential processing illustrated in FIG. 6.

If the server 120 receives the e-mail transmitted in step S308, then in step S311, the server 120 confirms the usage condition relating to the e-mail address having been set in an e-mail destination (e.g., a “To” field of a header of the e-mail) and performs processing based on the confirmed condition. The processing performed in step S311 corresponds to sequential processing to be performed in steps S1301 to S1307, S1321, and S1322 illustrated in FIG. 9.

In step S312, the server 120 transmits print data generated in the processing of step S311 to the image forming apparatus 140 that corresponds to the e-mail address. The processing performed in step S312 corresponds to processing to be performed in step S1308 illustrated in FIG. 9.

If the image forming apparatus 140 receives the print data, then in step S313, it causes the printer unit 145 to perform printing based on the received print data. In step S314, the image forming apparatus 140 notifies the server 120 of a print result. The processing performed in steps S313 and S314 corresponds to sequential processing illustrated in FIG. 4.

If the server 120 receives the print result, then in step S315, the server 120 updates relevant data that corresponds to the usage condition relating to the e-mail address (e.g., the number of print operations, the number of printed sheets, etc.). The processing performed in step S315 corresponds to processing to be performed in steps S1309 to S1311 illustrated in FIG. 9.

Now, detailed processing that can be performed by the image forming apparatus 140 according to the present exemplary embodiment is described below with reference to FIGS. 3 and 4. The control unit 141 of the image forming apparatus 140 can perform the processing of the flowcharts illustrated in FIGS. 3 and 4.

FIG. 3 is a flowchart illustrating an example of processing that can be performed by the image forming apparatus 140 to perform the processing in steps S301, S302, and S305 illustrated in FIG. 2 according to the present exemplary embodiment. First, in step S501, the control unit 141 receives a user's input designating the usage condition of the e-mail address that can be used to identify the image forming apparatus 140. Thus, it is understood that the usage condition of the e-mail address reflecting the user's instruction is receivable in step S501.

In the present exemplary embodiment, the e-mail address is information for identifying the image forming apparatus 140 that performs printing based on image data (which may be simply referred to as an image). Further, the image forming apparatus 140 can refer to the e-mail address to determine whether to perform printing based on the image data.

The usage condition of an e-mail address (which may be simply referred to as a usage condition) is a condition to be satisfied to permit e-mail address dependent printing. An example of the “usage condition” is “the e-mail address dependent printing can be permitted up to five times.” Further, an e-mail address, if it satisfies the above-described “usage condition” to perform the e-mail address dependent printing, is referred to as a conditional e-mail address.

Next, in step S502, the control unit 141 requests the server 120 to issue a conditional e-mail address based on the usage condition received in step S501. More specifically, the request transmitted from the control unit 141 to the server 120 in step S502 includes the usage condition of the e-mail address instructed by the user and an identifier (ID) that uniquely discriminates (identifies) the image forming apparatus 140.

In addition to the above-described information included in the request, the control unit 141 transmits information indicating an e-mail address of an administrator who manages the image forming apparatus 140. Further, it is useful that the control unit 141 requests the user to input a password allocated to the administrator of the image forming apparatus 140 and executes the processing in step S502 if the input of the administrator password is confirmed via the operation unit 143.

In step S503, the control unit 141 receives an e-mail address notification from the server 120 that has received the information transmitted in step S502. In step S504, the control unit 141 determines whether the issuance of the e-mail address is successfully completed. If it is determined that the issuance of the e-mail address is successfully completed (Yes in step S504), then in step S505, the control unit 141 causes the operation unit 143 to display a QR code (trademark) that represents the e-mail address and terminates the processing of the flowchart illustrated in FIG. 3. On the other hand, if it is determined that the issuance of the e-mail address is not successfully completed (No in step S504), then in step S506, the control unit 141 causes the operation unit 143 to display a message informing a failure in the e-mail address issuance and terminates the processing of the flowchart illustrated in FIG. 3.

FIG. 4 is a flowchart illustrating an example of processing that can be performed by the image forming apparatus 140 to perform the processing in step S313 and step S314 illustrated in FIG. 2 according to the present exemplary embodiment.

In step S601, the control unit 141 waits for the print data to be transmitted from the server 120. If the server 120 transmits the print data, then in step S602, the control unit 141 receives the print data. In step S603, the control unit 141 causes the printer unit 145 to perform printing based on the received print data. In step S604, the control unit 141 notifies the server 120 of a print result and terminates the processing of the flowchart illustrated in FIG. 4. In the following description, the “print data” may be simply referred to as an image.

Now, detailed processing that can be performed by the mobile 110 according to the present exemplary embodiment is described below with reference to FIGS. 5 and 6. The control unit 111 of the mobile 110 can perform the processing of flowcharts illustrated in FIGS. 5 and 6.

FIG. 5 is a flowchart illustrating an example of processing that can be performed by the mobile 110 to perform the processing in step S306 according to the present exemplary embodiment.

In step S801, the control unit 111 causes the camera unit 117 to read the QR code (trademark) displayed in step S305 and acquires the e-mail address from the QR code (trademark). Then, in step S802, the control unit 111 stores the acquired e-mail address in the flash memory (not illustrated), for example, a storage area corresponding to an address book of the flash memory, of the control unit 111.

FIG. 6 is a flowchart illustrating an example of processing that can be performed by the mobile 110 in step S307 and step S308 according to the present exemplary embodiment.

In step S901, the control unit 111 sets image data of a print target as an attachment file, to instruct printing of the image data, and generates an e-mail including an e-mail address having been set to identify the image forming apparatus 140 that performs printing based on the image data. Then, in step S902, the control unit 111 transmits the e-mail.

Detailed processing that can be performed by the server 120 according to the present exemplary embodiment is described below with reference to FIGS. 7, 8, and 9. The control unit 121 of the server 120 can perform the processing of the flowcharts illustrated in FIGS. 7 and 9.

FIG. 7 is a flowchart illustrating an example of the processing that can be performed by the server 120 in steps S303 and S304 illustrated in FIG. 2 according to the present exemplary embodiment.

In step S1101, the control unit 121 receives a conditional e-mail address issuance request from the image forming apparatus 140. The request transmitted from the image forming apparatus 140 to the control unit 121 in step S1101 includes information indicating the ID of the image forming apparatus 140 transmitted by the image forming apparatus 140 in step S502, the usage condition of an e-mail address (i.e., the usage condition) instructed by the user, and the e-mail address of the administrator who manages the image forming apparatus 140.

In step S1103, the control unit 121 determines whether the usage condition received in step S1101 is normal. If it is determined that the received usage condition is not normal, the processing proceeds to step S1110. In step S1110, the control unit 121 causes the operation unit 143 of the image forming apparatus 140 to display a message informing a failure in the conditional e-mail address issuance and terminates the processing of the flowchart illustrated in FIG. 7.

If it is determined that the usage condition is normal (Yes in step S1103), then in step S1104, the control unit 121 generates a conditional e-mail address (i.e., an e-mail address to which the usage condition received in step S1101 is set).

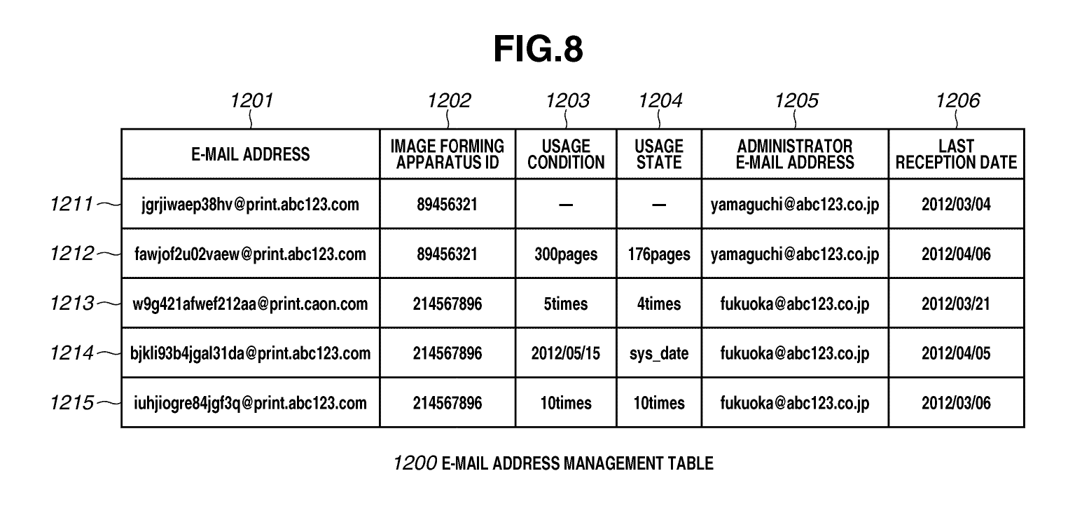

Then, in step S1105, the control unit 121 generates e-mail address management data, i.e., one record of an e-mail address management table 1200 illustrated in FIG. 8, for the e-mail address generated in step S1104. The control unit 121 can use the e-mail address management table 1200 to manage the generated e-mail address. In this respect, the control unit 121 registers the e-mail address while associating respective data (including e-mail address) of each record stored in the e-mail address management table 1200 illustrated in FIG. 8. The table management unit manages the e-mail address management table 1200. The e-mail address management table regarding the processing in step S1105 is described in detail below with reference to FIG. 8.

Finally, in step S1106, the control unit 121 issues the generated conditional e-mail address to the image forming apparatus 140 and terminates the processing of the flowchart illustrated in FIG. 7.

If the control unit 121 does not receive any usage condition in step S1101, the control unit 121 issues an e-mail address to which no usage condition is set.

Further, in the conditional e-mail address issuance processing according to the present exemplary embodiment, which has been described with reference to FIG. 7, the control unit 121 issued the conditional e-mail address for the image forming apparatus 140 after associating and registering respective data of the e-mail address management table 1200. However, the order in the registration and issuance processing according to the present exemplary embodiment of the claimed invention is not limited to the one illustrated in FIG. 7. For example, it is useful that the control unit 121 generates a conditional e-mail address and issues the generated conditional e-mail address to the image forming apparatus 140. Then, the control unit 121 mutually associates respective data (including the conditional e-mail address) of the e-mail address management table 1200 and registers the e-mail address.

FIG. 8 illustrates the e-mail address management table 1200, which is stored in the HDD of the control unit 121, to manage each e-mail address if the server 120 allocates it to a corresponding image forming apparatus.

The e-mail address management table 1200 includes a plurality of records, each being composed of a group of data (or information) representing an e-mail address 1201, an image forming apparatus ID 1202, a usage condition 1203, a usage state 1204, an administrator e-mail address 1205, and a last reception date 1206. In the present exemplary embodiment, the data of respective records can be collectively referred to as e-mail address management data. More specifically, the control unit 121 can create one record of the e-mail address management table 1200 by associating the above-described data (1201 to 1206) with one another when the control unit 121 performs the processing in step S1105.

The e-mail address 1201 is an e-mail address generated in step S1104, which corresponds to the image forming apparatus ID 1202.

The image forming apparatus ID 1202 is an ID of the image forming apparatus 140, which has transmitted the conditional e-mail address issuance request in step S1101 and is identified by the e-mail address 1201 as well.

The usage condition 1203 is information indicating the usage condition having been received in step S1101, which is associated with the e-mail address 1201. The usage condition 1203 is information indicating a condition to be used in determining whether to print image data attached to an e-mail transmitted to the e-mail address 1201 by the image forming apparatus 140 corresponding to the image forming apparatus ID 1202.

For example, if the usage condition 1203 is “300 pages”, the image data transmitted to the e-mail address 1201 is printable repetitively unless the cumulative number of sheets of a product printed by the image forming apparatus 140 exceeds 300 pages. If the usage condition 1203 is blank (see record 1211) in FIG. 8, it means that no usage condition is set for the e-mail address (namely, there is not any restriction for the printing to be performed by the image forming apparatus 140).

The usage state 1204 is information to be compared with the usage condition 1203 when the system determines whether to permit the usage of the e-mail address 1201 in printing. Further, the usage state 1204 is information indicating a result of the printing having been performed based on the e-mail address 1201. The usage state 1204 is dependent on the type of the usage condition 1203 that belongs to the same e-mail address management data.

For example, if the usage condition is the number of print operations (see records 1213 and 1215), the usage state indicates the total number of print operations having been performed. Further, if the usage condition is the number of pages (see record 1212), the usage state indicates the cumulative number of pages having been printed.

Further, if the usage condition is a date (see record 1214), the usage state is “sys_date” that is a value indicating that the control unit 121 refers to the system date to determine whether to satisfy the usage condition based on the system date. Regarding the record 1214, the content of the usage condition 1203 is a date. Therefore, it is understood that the control unit 121 refers to the system date to determine whether to satisfy the usage condition. Therefore, the usage state can be set to blank.

The administrator e-mail address 1205 is an e-mail address of an administrator who manages the image forming apparatus to which the image forming apparatus ID 1202 is allocated. In other words, the administrator e-mail address 1205 is the e-mail address of the administrator who manages the image forming apparatus 140, which has been received in step S1101.

The last reception date 1206 indicates the last reception date of the e-mail that was transmitted to the e-mail address 1201 and received by the server 120.

As illustrated in FIG. 8, it is possible to define an e-mail address having another usage condition for the same image forming apparatus ID 1202. More specifically, a plurality of e-mail addresses differentiated in usage condition for the same image forming apparatus can be issued.

FIG. 9 is a flowchart illustrating an example of processing that can be performed by the server 120 insteps S311, S312, and S315 illustrated in FIG. 2 according to the present exemplary embodiment.

First, in step S1301, the control unit 121 receives the e-mail transmitted by the mobile 110 in step S308 in FIG. 2. The control unit 121 temporarily stores data of the received e-mail in the HDD of the control unit 121.

In step S1302, the control unit 121 searches the e-mail address management table 1200 (illustrated in FIG. 8) to find the presence of and acquire e-mail address management data whose e-mail address 1201 is identical to the e-mail address having been set as a destination of the received e-mail.

In step S1303, the control unit 121 determines whether the intended e-mail address management data has been successfully acquired, as a result of the search performed in step S1302. If the e-mail address management data has been successfully acquired (Yes in step S1303), the processing of the control unit 121 proceeds to step S1304. On the other hand, if the control unit 121 fails to acquire the intended e-mail address management data (No in step S103), the processing proceeds to step S1321.

If the e-mail address management data designated as the destination of the received e-mail has not been successfully acquired from the e-mail address management table 1200 (No in step S1303), then in step S1321, the control unit 121 discards (deletes) the e-mail data stored in step S1301 from the HDD of the control unit 121. Then, in step S1322, the control unit 121 sends an error notification e-mail to the mobile 110. For example, the error notification is an ordinary e-mail including a message “no user is present.” Alternatively, the error notification can include a message “not the e-mail address corresponding to the image forming apparatus”, which is easier for the user to understand.

If the control unit 121 has successfully acquired the intended e-mail address management data from the e-mail address management table 1200 through the search processing performed in step S1302, then in step S1304, the control unit 121 updates the last reception date 1206 by the system date.

Next, in step S1305, the control unit 121 determines whether the e-mail address designated as the destination of the received e-mail is a conditional e-mail address with reference to the usage condition 1203 of the acquired e-mail address management data. If it is determined that the usage condition 1203 of the acquired e-mail address management data is not blank, the control unit 121 determines that the e-mail address is the conditional e-mail address.

If it is determined that the designated e-mail address is not a conditional e-mail address (No in step S1305), the control unit 121 skips the next step S1306. The processing directly proceeds to step S1307. If it is determined that the designated e-mail address is a conditional e-mail address (Yes in step S1305), the processing proceeds to step S1306. In step S1306, the control unit 121 determines whether a state corresponding to the conditional e-mail address can satisfy the usage condition by referring to the usage condition 1203 and the usage state 1204 that correspond to the conditional e-mail address.

In the above-described determination processing, the control unit 121 determines whether the usage state 1204 of the acquired e-mail address management data satisfies the usage condition 1203 by comparing the information indicated by the usage condition 1203 with the information indicated by the usage state 1204. According to the e-mail address management data 1212, the usage condition 1203 is 300 pages and the usage state 1204 is 176 pages. Therefore, in step S1306, the control unit 121 determines that the usage state 1204 satisfies the usage condition 1203 (i.e., 300 pages>176 pages).

If it is determined that the usage condition is not satisfied (No in step S1306), then in step S1321, the control unit 121 discards the received e-mail data from the HDD. Further, in step S1322, the control unit 121 sends an error notification e-mail to the mobile 110. For example, the error notification includes a simple message “the e-mail address is unusable.” Alternatively, the error notification can include a message “the e-mail address does not satisfy the usage condition”, which is easier for the user to understand.

On the other hand, if it is determined that the usage condition is satisfied (Yes in step S1306), then in step S1307, the control unit 121 generates print data based on the received e-mail body and the attached image data.

Next, in step S1308, the control unit 121 transmits the generated print data to the image forming apparatus 140 that corresponds to the image forming apparatus ID 1202 of the e-mail address management data acquired in steps S1302 and S1303.

The sequential processing in steps S1306 to S1308 according to the present exemplary embodiment can be summarized in the following manner. In step S1306, the control unit 121 is functionally operable as a determining unit configured to receive an image attached to an e-mail whose destination is set to a conditional e-mail address and configured to determine whether to print the received image by the image forming apparatus 140 that can be identified by the conditional e-mail address. Further, in steps S1307 and S1308 that follow step S1306, the control unit 121 is functionally operable as a transmitting unit configured to transmit the image received in step S1306 to the image forming apparatus 140 that can be identified by the conditional e-mail address.

Subsequently, in step S1309, the control unit 121 receives a print result from the image forming apparatus 140. Then, in step S1310, the control unit 121 determines whether the print result indicates a normal termination. If it is determined that the print result indicates the normal termination (Yes in step S1310), then in step S1311, the control unit 121 updates the usage state 1204 of the e-mail address management table 1200 and terminates the processing of the flowchart illustrated in FIG. 9. For example, if the usage condition is the number of print operations, the control unit 121 increments (adds 1 to) the number of print operations of the usage state 1204. If it is determined that the print result does not indicate the normal termination (No in step S1310), the control unit 121 terminates the processing of the flowchart illustrated in FIG. 9 without updating the usage state 1204 of the e-mail address management table 1200.

As described above, the procedure described in the present exemplary embodiment refers to a conditional e-mail address to restrict the printing. Therefore, the system according to the present exemplary embodiment can prevent the image forming apparatus 140 from performing print processing unrestrictedly.

In the present exemplary embodiment, the control unit 121 issues an e-mail address to be used as e-mail destination information when an e-mail including an attached image is transmitted in association with a condition (or a requirement) to be satisfied to perform printing in the image forming apparatus 140. However, the claimed invention is not limited to the above-described embodiment. For example, the control unit 121 can issue requirement information (i.e., information associated with a condition that restricts printing by the image forming apparatus 140).

For example, the control unit 121 can issue a unique e-mail address dedicated to an image forming apparatus in response to an e-mail address issuance request. Further, in addition to the unique e-mail address, the control unit 121 can issue requirement information associated with various conditions restricting the printing by the image forming apparatus 140 (e.g., the usage condition 1203, the usage state 1204, and the last reception date 1206 illustrated in FIG. 8). In this case, for example, the control unit 111 transmits, to the control unit 121, an e-mail whose destination is set to the issued unique e-mail address and including a print target image and the requirement information attached thereto. Then, the control unit 121 can determine whether to perform printing of the received image with reference to the received requirement information.

Now, a printing system according to a second exemplary embodiment is described below. In the first exemplary embodiment, each e-mail address cannot be used any more if it does not satisfy the usage condition. The printing system according to the present exemplary embodiment is configured to reuse the same e-mail address repetitively by resetting the usage state.

In the present exemplary embodiment, the conditional e-mail address that does not satisfy the usage condition is defined as a suspended e-mail address. The system according to the present exemplary embodiment is configured to enable an administrator to determine whether to permit printing if a received e-mail includes a suspended e-mail address as its destination (e.g., the “To” field of the e-mail header).

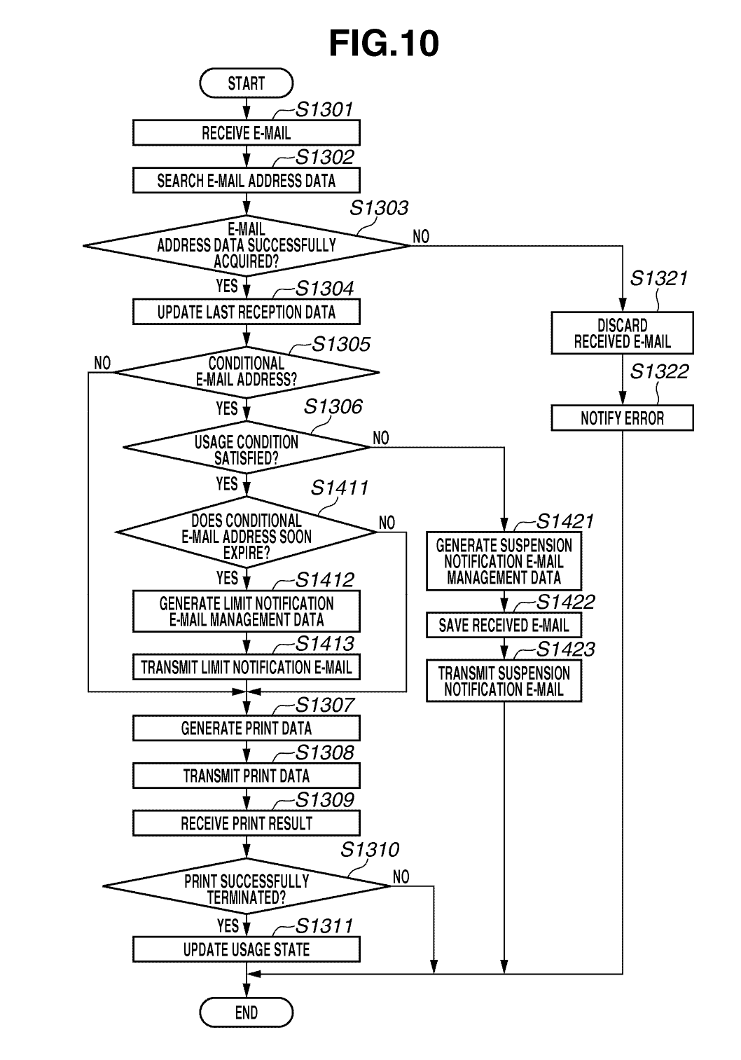

Hereinafter, differences between the present exemplary embodiment and the first exemplary embodiment are described in detail below with reference to FIG. 10. The present exemplary embodiment is different from the first exemplary embodiment in that the sequential processing performed by the server 120 described in the first exemplary embodiment with reference to FIG. 9 is replaced by sequential processing described in detail below with reference to the flowchart illustrated in FIG. 10.

FIG. 10 is a flowchart illustrating an example of processing that can be performed by the control unit 121 of the server 120. The flowchart illustrated in FIG. 10 includes a newly added processing flow not included in the flowchart illustrated in FIG. 9. The flowchart illustrated in FIG. 10 is differentiated from the flowchart illustrated in FIG. 9 by providing additional sequential processing (steps S1411 to S1413 and steps S1421 to S1423) to be performed after completing the determination processing in step S1306. Processing to be performed in each step is similar to that described in the flowchart illustrated in FIG. 9 if the concerned step has the same number as that described in FIG. 9.

In step S1306 illustrated in FIG. 10, the control unit 121 determines whether the conditional e-mail address satisfies the usage condition. If it is determined that the conditional e-mail address satisfies the usage condition (Yes in step S1306), the processing proceeds to step S1411. On the other hand, if it is determined that the conditional e-mail address does not satisfy the usage condition (No in step S1306), the processing proceeds to step S1421.

In step S1411, the control unit 121 determines if the possibility that the image forming apparatus 140 cannot perform printing based on the conditional e-mail address is high. More specifically, the control unit 121 determines whether the conditional e-mail address will soon expire. The determination in step S1411 can be realized based on a comparison between the usage condition 1203 and the usage state 1204 with respect to the conditional e-mail address.

In determining the expiration of the conditional e-mail address, it is useful to statically set an appropriate value beforehand according to the type of the usage condition 1203 (e.g., number of print operations, number of printed pages, or printable date). Further, it is also useful to use a calculated value that can be obtained by multiplying the usage condition by a constant coefficient for each conditional e-mail address.

For example, in a case where the type of the usage condition 1203 is the number of print operations (see record 1213 illustrated in FIG. 8), if a difference between the number of print operations in usage condition 1203 and the number of print operations in usage state 1204 is equal to or less than a threshold value, the control unit 121 determines that the conditional e-mail address will soon expire. Alternatively, if the number of print operations in usage state 1204 is equal to or less than a determination threshold (e.g., four times), which can be obtained by multiplying the number of print operations in usage condition 1203 (e.g., five times) by a coefficient 0.8, the control unit 121 determines that the conditional e-mail address will soon expire.

If it is determined that the conditional e-mail address will soon expire (Yes in step S1411), the processing of the control unit 121 proceeds to step S1412. On the other hand, if it is determined that the conditional e-mail address will not soon expire (No in step S1411), the processing proceeds to step S1307.

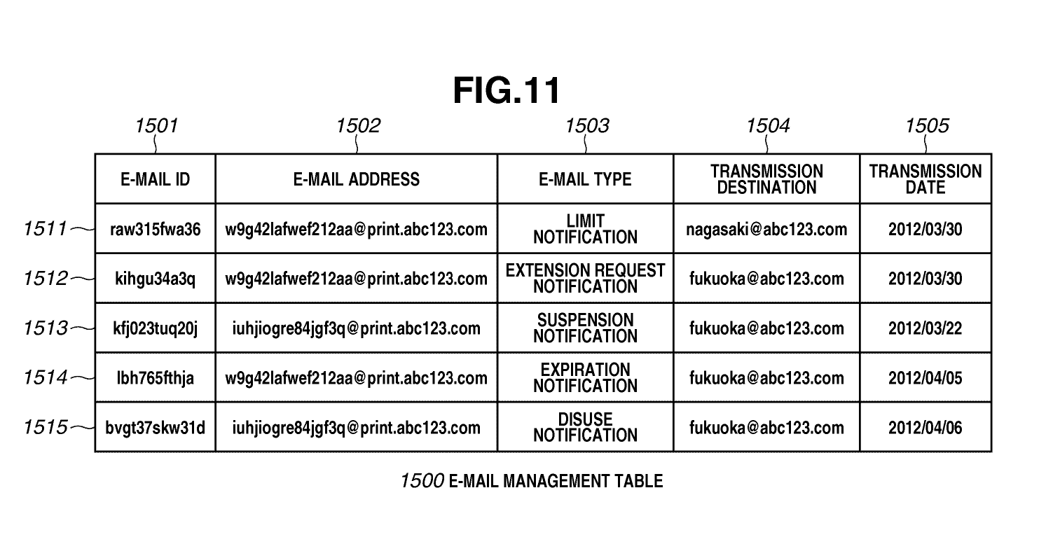

In step S1412, the control unit 121 generates e-mail management data for a limit notification (see a record 1511 illustrated in FIG. 11). In the present exemplary embodiment, the limit notification is sending an e-mail that notifies a sender of the e-mail received in step S1301 of expiration of the conditional e-mail address. Further, the limit notification is sending, to the sender of the e-mail received in step S1301, information that requests the administrator of the image forming apparatus 140 to extend the limit of the usage condition 1203. In the present exemplary embodiment, the e-mail management data is used to manage various notifications including the limit notification. FIG. 11 illustrates an e-mail management table 1500 (which will be described below) that can be used to manage the e-mail management data. The table management unit manages the e-mail address management table 1500.

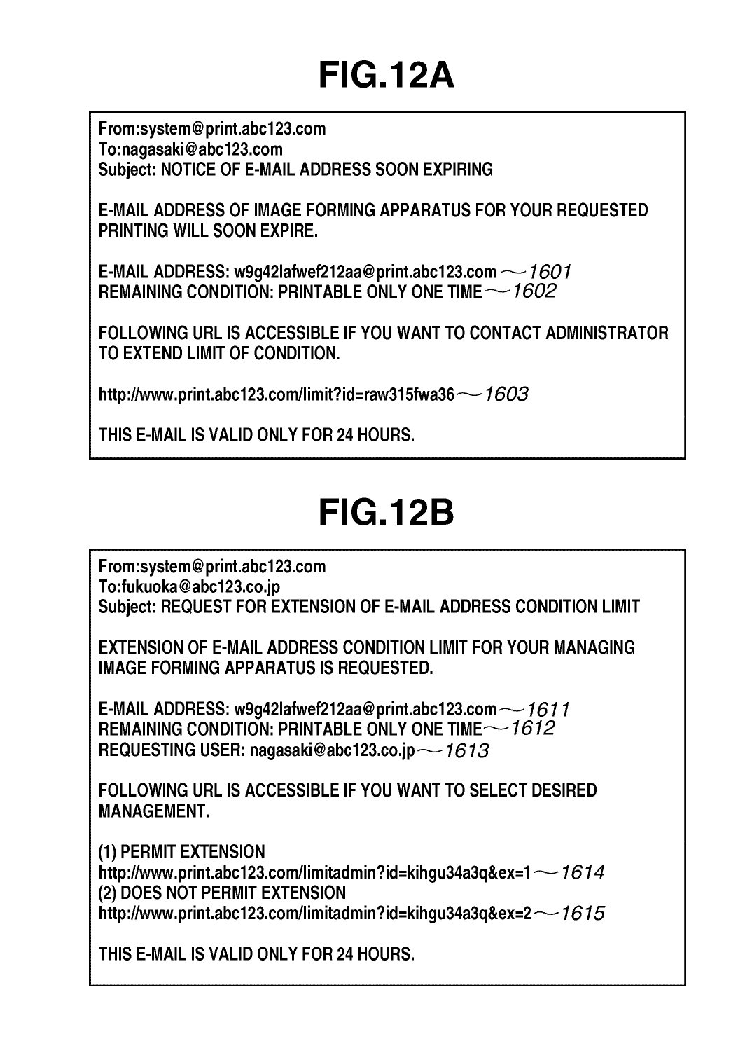

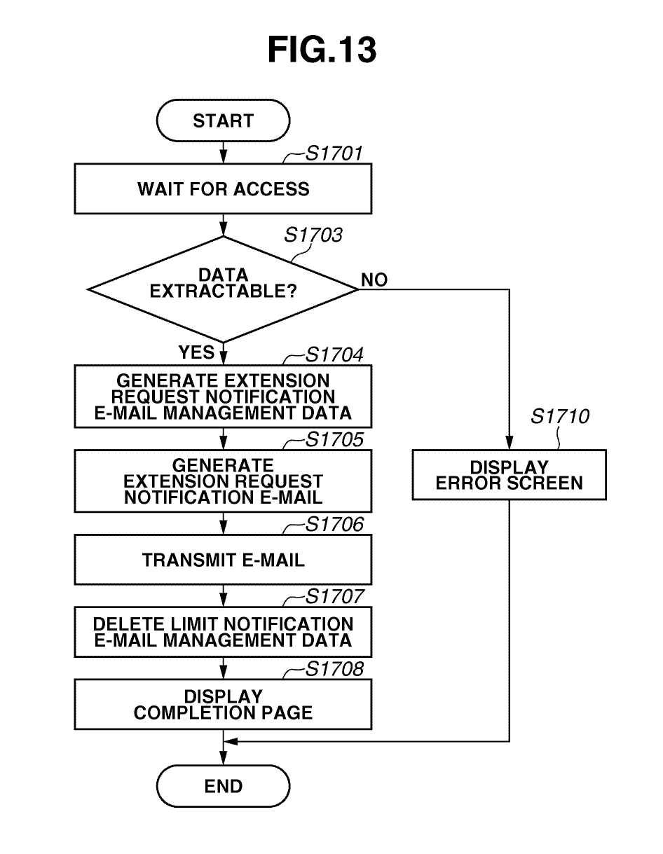

In step S1413, the control unit 121 generates a limit notification e-mail and transmits the generated limit notification e-mail to the sender of the e-mail received in step S1301 (e.g., the e-mail address described in the “From” field of the e-mail header). A procedure of processing that can be performed by the control unit 121 of the server 120, after completing the transmission of the limit notification e-mail in step S1413, is described in detail below with reference to FIGS. 12A, 12B, and 13.

On the other hand, in step S1421, the control unit 121 generates e-mail management data for a suspension notification (see a record 1513 illustrated in FIG. 11). In the present exemplary embodiment, the suspension notification is sending an e-mail that notifies the administrator of the image forming apparatus 140 of an e-mail transmission to the conditional e-mail address that does not satisfy the usage condition. Further, the suspension notification is sending, to the administrator of the image forming apparatus 140, information usable to determine whether to permit printing the e-mail transmitted to the conditional e-mail address that does not satisfy the usage condition.

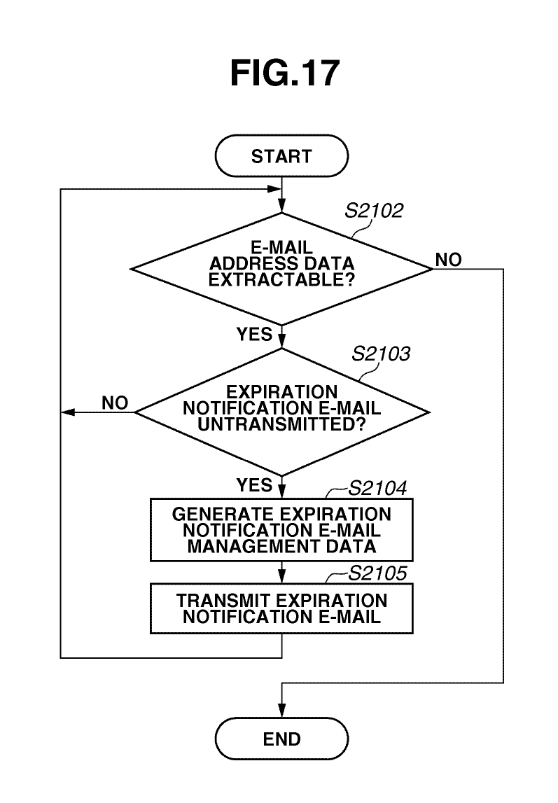

If an e-mail type of the conditional e-mail address is a suspension notification (see an e-mail type 1503 of the record 1513 illustrated in FIG. 11), the control unit 121 periodically performs sequential processing described below with reference to FIGS. 17 to 22.

Then, in step S1422, the control unit 121 links (associates) the received e-mail data (which has been received and stored in step S1301) with an e-mail ID of the suspension notification (i.e., an e-mail ID 1501 of the record 1513 illustrated in FIG. 11) so that the received e-mail data can be later extracted. The control unit 121 continuously stores the received e-mail data in the HDD of the control unit 121, without deleting any part of the received e-mail data. The above-described sequential processing to be performed by the control unit 121 can be referred to as reception e-mail saving processing.

As described in detail below with reference to FIG. 11, the e-mail ID 1501 is associated with an e-mail address 1502 that corresponds to the image forming apparatus. Therefore, the received e-mail data is also associated with the e-mail address 1502. As understood from the foregoing description, in step S1422 (i.e., a step that follows step S1306), the control unit 121 including the HDD is functionally operable as a unit configured to store an image attached to a received e-mail in the HDD while associating it with an e-mail address (conditional e-mail address) without transmitting the attached image to the image forming apparatus 140.

For example, if a received e-mail includes an attachment file, storing each received e-mail as a file whose file name is the e-mail ID is an exemplary method for linking the received e-mail with the suspension notification e-mail ID.

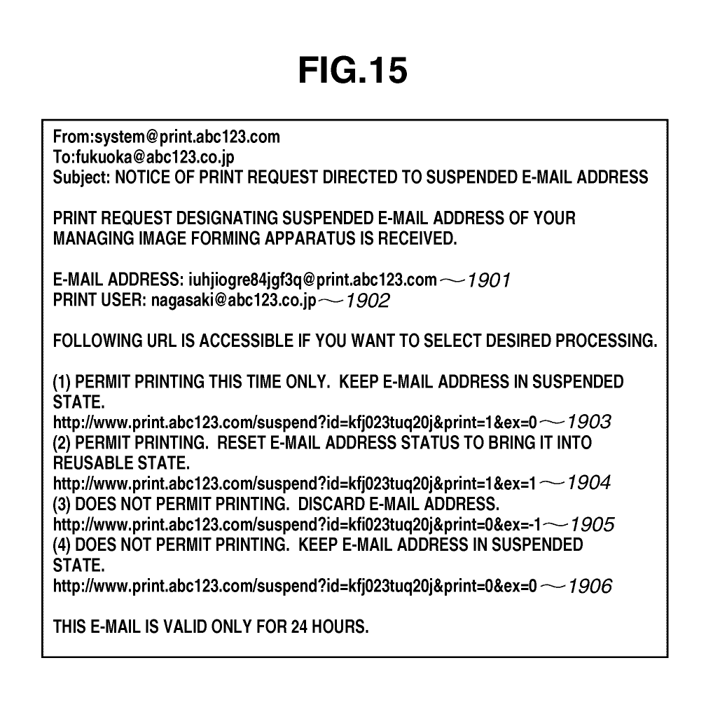

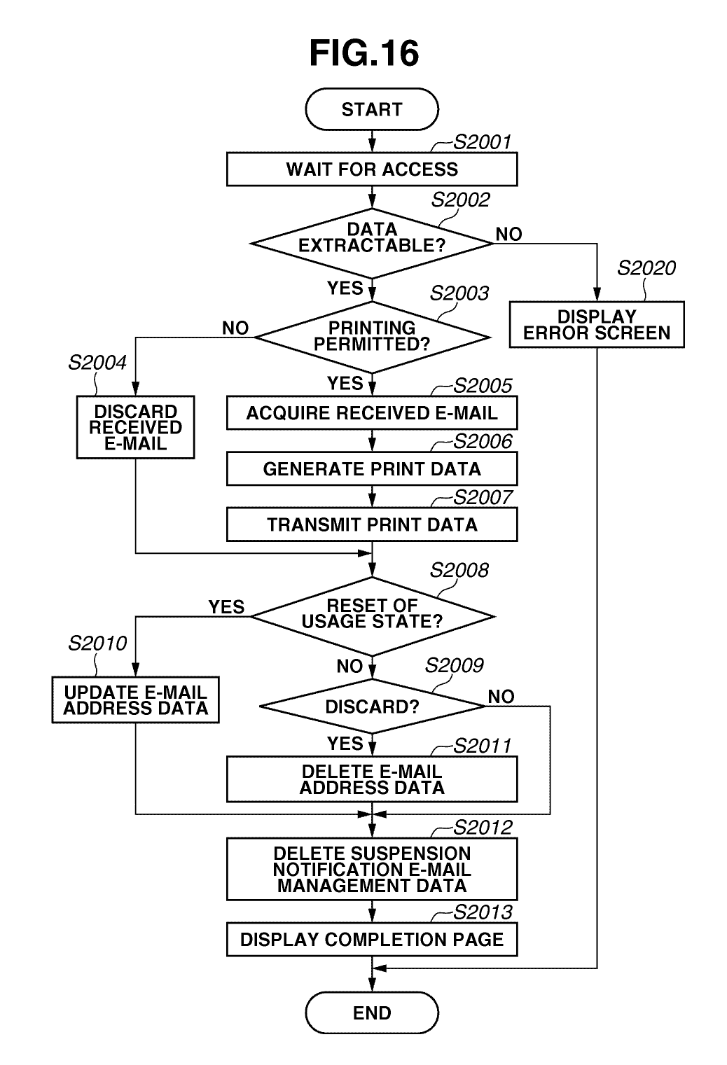

Then, in step S1423, the control unit 121 generates an e-mail of the suspension notification illustrated in FIG. 15. Further, the control unit 121 sets, as a destination of the e-mail, the administrator e-mail address 1205 included in the e-mail address management data acquired through the search processing in step S1302. Then, the control unit 121 transmits the generated suspension notification e-mail to the destination. A procedure of processing that can be performed by the control unit 121 of the server 120, after completing the transmission of the suspension notification e-mail in step S1423, is described in detail below with reference to FIGS. 15 and 16.

FIG. 11 illustrates the e-mail management table 1500 generated by the control unit 121 and stored in the HDD to enable the server 120 to manage the data to be used to manage various notifications (including the limit notification and the suspension notification as described above) included in each e-mail.

The e-mail management table 1500 includes a plurality of records, each being composed of a group of data (or information) representing the e-mail ID 1501, the e-mail address 1502, the e-mail type 1503, a transmission destination 1504, and a transmission date 1505. The respective data of each record are associated with one another so that the control unit 121 can refer to other data by designating one data in the same record. The data of respective records can be collectively referred to as e-mail management data. To set an appropriate term of validity applied to a Uniform Resource Locator (URL) described in each notification e-mail, the e-mail management data can be automatically deleted when a predetermined time (e.g., 24 hours according to the notification examples illustrated in FIGS. 12A, 12B, and 15) has elapsed since the transmission of the notification e-mail.

The e-mail ID 1501 indicates an e-mail ID that can be used to uniquely identify the e-mail transmitted by the server 120. The e-mail address 1502 corresponds to the image forming apparatus 140, and indicates a target e-mail address of the notification e-mail. The e-mail type 1503 indicates the type of each notification (e.g., “limit notification” or “suspension notification”). The transmission destination 1504 indicates a transmission destination e-mail address of the notification e-mail. The transmission date 1505 indicates the date when the notification e-mail was transmitted.

For example, each record of the e-mail management data can be generated according to the following procedure. First, the control unit 121 generates the e-mail ID 1501. Next, the control unit 121 sets respective e-mail addresses of the transmission destination (e.g., the “To” field of the e-mail header) and the transmission source (e.g., the “From” field of the e-mail header) of the e-mail received in step S1301 as the e-mail address 1502 and the transmission destination 1504. Further, the control unit 121 sets the type and the transmission date of the e-mail transmitted in step S1413 or step S1423 as the e-mail type 1503 and the transmission date 1505. Finally, the control unit 121 generates one record of the e-mail management data by associating respective data of the record with one another.

A procedure of processing that can be performed by the control unit 121 of the server 120, after completing the transmission of the limit notification e-mail in step S1413, is described in detail below with reference to FIGS. 12A, 12B, and 13.

FIG. 12A illustrates an example of the limit notification e-mail. The limit notification e-mail includes descriptions of a target conditional e-mail address 1601, a remaining usage condition 1602, and a URL 1603 (i.e., information that can be used to request the administrator to extend the limit of the usage condition). The URL 1603 includes address information (e.g., http://www.print.abc123.com/limit) of the server 120 together with the e-mail ID (e.g., “raw315fwa36” that follows “id=”) usable to uniquely identify the limit notification e-mail transmitted by the control unit 121 in step S1413, which are allocated as parameters. The e-mail ID can be managed as the e-mail ID 1501 in the e-mail management table 1500 illustrated in FIG. 11.

FIG. 13 is a flowchart illustrating an example of sequential processing that can be performed by the control unit 121 of the server 120, when the mobile 110 accesses the URL 1603 described in the limit notification e-mail (described in FIG. 12A).

In step S1701, the control unit 121 waits for an access to the URL described in the limit notification e-mail.

If there is an access to the URL described in the limit notification e-mail, the control unit 121 tries to extract, from the e-mail management table 1500, e-mail management data including the e-mail ID 1501 that coincides with the e-mail ID set as a URL parameter. Further, if it is determined that the e-mail management data is extractable, in step S1703, the control unit 121 tries to extract, from the e-mail address management table 1200, e-mail address management data including the e-mail address 1201 that coincides with the e-mail address 1502 of the e-mail management data.

If it is determined that either one of the e-mail management data and the e-mail address management data is not extractable (No in step S1703), then in step S1710, the control unit 121 transmits an error screen to the mobile 110 and causes the display unit 115 of the mobile 110 to display the error screen. Then, the control unit 121 terminates the processing of the flowchart illustrated in FIG. 13.

If it is determined that both of the e-mail management data and the e-mail address management data are extractable (Yes in step S1703), then in step S1704, the control unit 121 generates e-mail management data for an extension request notification (see a record 1512 illustrated in FIG. 11). In the present exemplary embodiment, the extension request notification is sending an e-mail that notifies the administrator of the image forming apparatus 140 of the reception of a request for extension of the limit of the usage condition transmitted to the conditional e-mail address. Further, the extension request notification is sending, to the administrator of the image forming apparatus 140, information usable to determine whether to permit extending the limit of the usage condition of the conditional e-mail address.

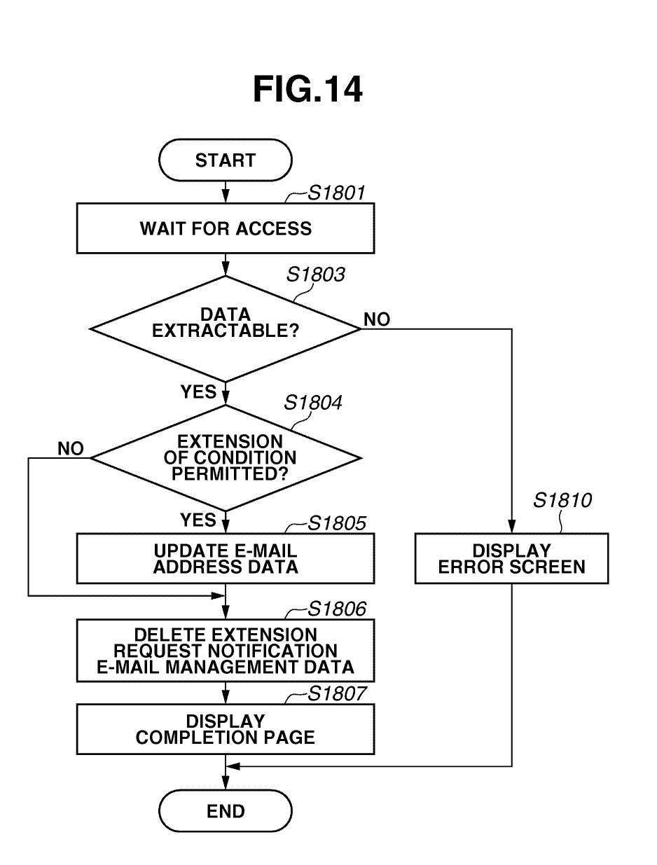

In step S1705, the control unit 121 generates an extension request notification e-mail. In step S1706, the control unit 121 transmits the generated extension request notification e-mail to the administrator e-mail address 1205 extracted from the e-mail address management data. A procedure of processing that can be performed by the control unit 121 of the server 120, after completing the transmission of the extension request notification e-mail in step S1706, is described in detail below with reference to FIGS. 12B and 14.

In step S1707, the control unit 121 deletes the unnecessary limit notification e-mail management data (i.e., a record 1511 illustrated in FIG. 11). The deletion target is the e-mail management data that has the e-mail ID described in the URL accessed in step S1701.

Then, in step S1708, the control unit 121 transmits a completion page indicating the completion of the sequential processing to the mobile 110 and causes the display unit 115 of the mobile 110 to display the completion page. Then, the control unit 121 terminates the processing of the flowchart illustrated in FIG. 13.

A procedure of processing that can be performed by the control unit 121 of the server 120, after completing the transmission of the extension request notification e-mail in step S1706, is described in detail below with reference to FIGS. 12B and 14.

FIG. 12B illustrates an example of the extension request notification e-mail. The extension request notification e-mail includes descriptions of a target conditional e-mail address 1611, a remaining usage condition 1612, an e-mail address of the transmission destination 1504 of the limit notification (more specifically, an e-mail address 1613 of a user who has requested the extension), and URLs 1614 and 1615 that are information usable to determine whether to permit the extension. Each of the URLs 1614 and 1615 includes address information (e.g., “http://www.print.abc123.com/limitadmin”) of the server 120 together with an e-mail ID (e.g., “kihgu34a3q” that follows “id=”) usable to uniquely identify the extension request notification e-mail transmitted by the control unit 121 in step S1706 and a numerical value (e.g., “1” that follows “ex=”) indicating the permissibility about the extension.

FIG. 14 is a flowchart illustrating an example of processing that can be performed by the control unit 121 of the server 120 in response to an access to the URL 1614 or 1615 described in the extension request notification e-mail from an information terminal owned by the administrator of the image forming apparatus 140.

In step S1801, the control unit 121 waits for an access to the URL described in the extension request notification e-mail.

If there is an access to the URL described in the extension request notification e-mail, the control unit 121 tries to extract, from the e-mail management table 1500, e-mail management data including the e-mail ID 1501 that coincides with the e-mail ID having been set as the URL parameter. Further, if it is determined that the e-mail management data is extractable, then in step S1803, the control unit 121 tries to extract, from the e-mail address management table 1200, e-mail address management data including the e-mail address 1201 that coincides with the e-mail address 1502 of the e-mail management data.

If it is determined that either the e-mail management data or the e-mail address management data is not extractable (No in step S1803), then in step S1810, the control unit 121 displays an error screen and terminates the processing of the flowchart illustrated in FIG. 14.

If it is determined that both of the e-mail management data and the e-mail address management data are extractable (Yes in step S1803), then in step S1804, the control unit 121 checks the value indicating the extendibility having been set as the URL parameter and determines whether to permit the extension.

If it is determined that the extension is impermissible (No in step S1804), the processing of the control unit 121 skips step S1805 to directly proceed to step S1806.

On the other hand, if it is determined that the extension is permissible (Yes in step S1804), then in step S1805, the control unit 121 updates the e-mail address management table 1200 to reset the usage state 1204 of the e-mail address management data extracted in step S1803 to an initial value.

In step S1806, the control unit 121 deletes the unnecessary extension request notification e-mail management data (i.e., record 1512 illustrated in FIG. 11). The deletion target is the e-mail management data that has the e-mail ID described in the URL accessed in step S1801.

Then, in step S1807, the control unit 121 displays a completion page that informs the completion of the sequential processing and terminates the processing of the flowchart illustrated in FIG. 14.

A procedure of processing that can be performed by the control unit 121 of the server 120, after completing the transmission of the suspension notification e-mail in step S1423, is described in detail below with reference to FIGS. 15 and 16.

FIG. 15 illustrates an example of the suspension notification e-mail. The suspension notification e-mail includes descriptions of a target conditional e-mail address 1901, a sender e-mail address 1902 of the e-mail received in step S1301, and URLs 1903 to 1906 that are information (selection information) usable to enable the administrator (or the user) to determine the printability and the procedure for the conditional e-mail address. Each of the URLs 1903 to 1906 includes address information (e.g., “http://www.print.abc123.com/suspend”) of the server 120 together with an e-mail ID (e.g., “kjf023tuq20j” that follows “id=”) usable to uniquely identify the suspension notification e-mail transmitted by the control unit 121 in step S1423.

Further, each of the URLs 1903 to 1906 includes a numerical value (e.g., “print=1” or “print=0”) indicating the printability and another numerical value (e.g., “ex=0”) indicating a procedure for the e-mail address, which are allocated as parameters. The printability indication value indicates whether received e-mail data (e.g., an image) associated with the e-mail ID 1501 of a suspension notification is to be printed by the image forming apparatus 140 that corresponds to the e-mail address 1502 associated with the e-mail ID 1501.

Hereinafter, the contents of the URLs 1903 to 1906 are described in detail below.

The URL 1903 indicates that the received e-mail data is to be printed because it includes the parameter “print=1” and indicates that the conditional e-mail address is in a suspended state because it includes the parameter “ex=0.” In the present exemplary embodiment, the suspended state indicates “being kept in a state where the usage condition is not satisfied.”

The URL 1904 indicates that the received e-mail data is to be printed because it includes the parameter “print=1” and indicates that the usage state of the conditional e-mail address has been reset and the conditional e-mail address is in a reusable state because it includes the parameter “ex=1.”

The URL 1905 indicates that the received e-mail data is not to be printed because it includes the parameter “print=0” and indicates that the conditional e-mail address is discarded (deleted) because it includes the parameter “ex=−1.”

The URL 1906 indicates that the received e-mail data is not to be printed because it includes the parameter “print=0” and indicates that the conditional e-mail address is continuously suspended because it includes the parameter “ex=0.”

FIG. 16 is a flowchart illustrating an example of sequential processing that can be performed by the control unit 121 of the server 120, when the information terminal (not illustrated) owned by the administrator (or the user) of the image forming apparatus 140 accesses one of the URLs 1903 to 1906, as a response to the suspension notification (see FIG. 15), based on an instruction of the administrator.

In step S2001, the control unit 121 waits for an access to the URL described in the suspension notification. The reception of an access to the URL in step S2001 indicates that the control unit 121 receives a parameter included in the URL, and corresponds to the reception of instruction information that causes the control unit 121 to perform processing to be performed in step S2002 and subsequent steps illustrated in FIG. 16.

If there is an access to the URL described in the suspension notification e-mail, the control unit 121 tries to extract, from the e-mail management table 1500, e-mail management data including the e-mail ID 1501 that coincides with the e-mail ID having been set as the URL parameter. Further, if it is determined that the e-mail management data is extractable, then in step S2002, the control unit 121 tries to extract, from the e-mail address management table 1200, e-mail address management data including the e-mail address 1201 that coincides with the e-mail address 1502 of the e-mail management data.

If it is determined that either the e-mail management data or the e-mail address management data is not extractable (No in step S2002), then in step S2020, the control unit 121 transmits an error screen to an information terminal (not illustrated) owned by the administrator of the image forming apparatus 140 and causes a display unit of the information terminal to display the error screen. Then, the control unit 121 terminates the processing of the flowchart illustrated in FIG. 16.

If it is determined that both of the e-mail management data and the e-mail address management data are extractable (Yes in step S2002), then in step S2003, the control unit 121 checks the value indicating the printability having been set as the URL parameter and determines whether to print the received e-mail data.

If it is determined that the value indicating the printability is “print=1” (Yes in step S2003), then in step S2005, the control unit 121 acquires a received e-mail corresponding to the e-mail ID having been set as the URL parameter from the received e-mails stored in the HDD of the control unit 121 in step S1422.

In step S2006, the control unit 121 generates print data (or an image) based on image data (i.e., an e-mail body and an attachment file) of the received e-mail acquired in step S2005.

Further, in step S2007, the control unit 121 transmits the generated print data to the image forming apparatus 140, which corresponds to the image forming apparatus ID 1202 of the e-mail address management data extracted in step S2002.

On the other hand, if it is determined that the value indicating the printability is “print=0” (No in step S2003), then in step S2004, the control unit 121 discards (deletes), from the HDD of the control unit 121, the received e-mail data that corresponds to the e-mail ID having been set as the URL parameter, of the received e-mails stored in the HDD of the control unit 121 in step S1422, without transmitting any received e-mail data to the image forming apparatus 140.

In steps S2008 and S2009, the control unit 121 checks the value representing the procedure for the e-mail address having been set as the URL parameter. As a check result, if it is determined that the usage state of the conditional e-mail address is reset (Yes in step S2008), the processing of the control unit 121 proceeds to step S2010.

If it is determined that the conditional e-mail address is discarded (No in step S2008 and Yes in step S2009), the processing of the control unit 121 proceeds to step S2011. Further, if it is determined that the e-mail address is kept in the suspended state or the value representing the procedure for the e-mail address is an invalid value (No in step S2009), the processing of the control unit 121 proceeds to step S2012.

In step S2010, the control unit 121 updates the e-mail address management table 1200 to reset the usage state 1204 of the e-mail address management data extracted in step S2002 to an initial value.

In step S2011, the control unit 121 deletes the e-mail address management data extracted in step S2002 from the e-mail address management table 1200.

Then, in step S2012, the control unit 121 deletes the unnecessary suspension notification e-mail management data (i.e., the record 1513 illustrated in FIG. 11). The deletion target record is the e-mail management data that has the e-mail ID described in the URL having been accessed in step S2001. Finally, in step S2013, the control unit 121 transmits a completion page that informs the completion of the sequential processing to the information terminal owned by the administrator of the image forming apparatus 140 and causes the display unit of the information terminal to display the completion page. Then, the control unit 121 terminates the processing of the flowchart illustrated in FIG. 16.

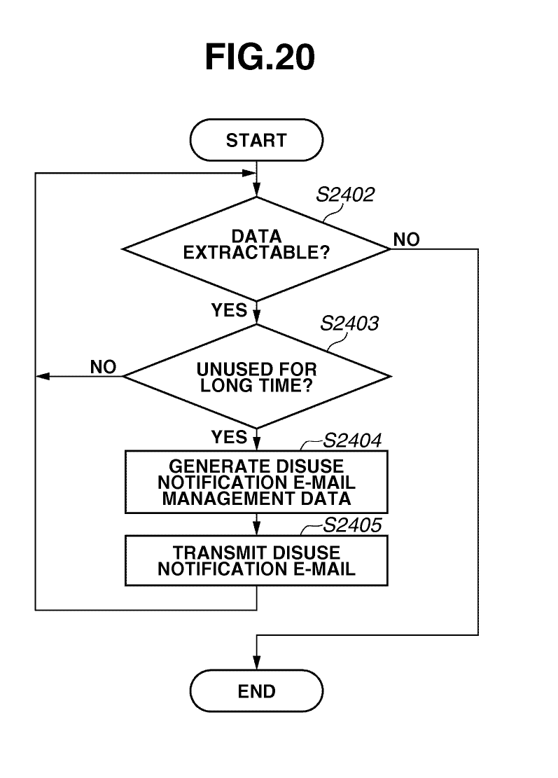

An example of sequential processing that can be performed by the control unit 121, when the conditional e-mail address is the suspension notification in the e-mail type of the e-mail management data (see FIG. 11), is described below with reference to FIG. 17 to FIG. 22. First, a processing procedure for the suspended e-mail address is described in detail below with reference to FIG. 17 to FIG. 19. Next, a processing procedure for the suspended e-mail address, which has not been used for a predetermined time, is described in detail below with reference to FIGS. 20 to 22.

A processing procedure for the suspended e-mail address is described in detail below with reference to FIGS. 17 to 19.

FIG. 17 is a flowchart illustrating exemplary processing that can be performed to transmit an e-mail for an expiration notification to the administrator of the image forming apparatus 140 who is associated with the suspended e-mail address. The sequential processing of the flowchart illustrated in FIG. 17 can be periodically (e.g., once a day) performed by the control unit 121.

In the present exemplary embodiment, the expiration notification is sending an e-mail, which informs that the conditional e-mail address does not satisfy the usage condition, to the administrator of the image forming apparatus 140. Further, the expiration notification is sending a notification, which includes information usable to determine the procedure for the suspended e-mail address, to the administrator of the image forming apparatus 140.

In step S2102, the control unit 121 determines whether any data relating to the suspended e-mail address is included in the e-mail address management data, which is managed using the e-mail address management table 1200, with reference to the e-mail management table 1500. The determination processing in step S2102 can be realized by checking if the e-mail type 1503 is the suspension notification.

If it is determined that there is not any data (No in step S2102), the control unit 121 terminates the processing of the flowchart illustrated in FIG. 17.

If it is determined that any data is present (Yes in step S2102), then in step S2103, the control unit 121 extracts one of the data and determines whether the expiration notification e-mail relating to the conditional e-mail address has been previously transmitted. To determine the previous transmission of the expiration notification e-mail, the control unit 121 can refer to the e-mail management table 1500 to check the presence of any expiration notification e-mail management data relating to the suspended e-mail address (a record whose e-mail type 1503 is the expiration notification illustrated in FIG. 11).

If it is determined that the expiration notification e-mail has been previously transmitted (No in step S2103), the processing of the control unit 121 returns to step S2102, in which the control unit 121 restarts the above-described processing for the next e-mail address management data.

If it is determined that the expiration notification e-mail is untransmitted (Yes in step S2103), then in step S2104, the control unit 121 generates expiration notification e-mail management data (see a record 1514 illustrated in FIG. 11).

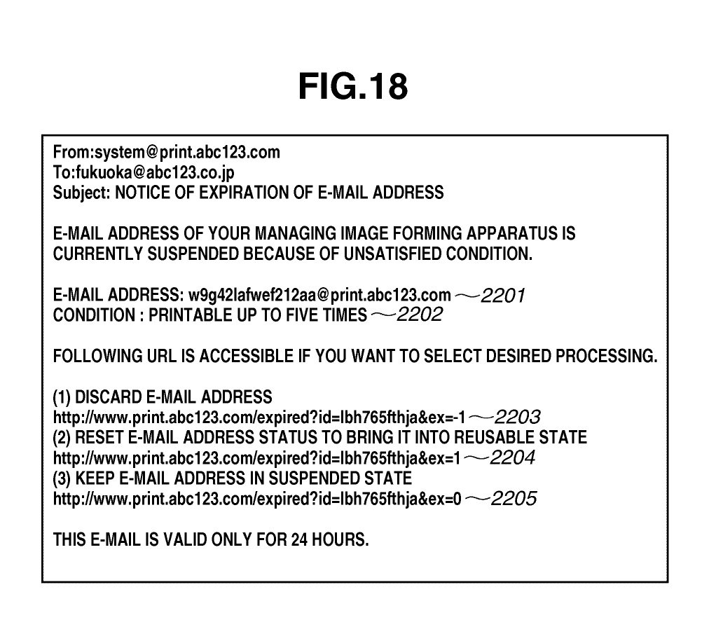

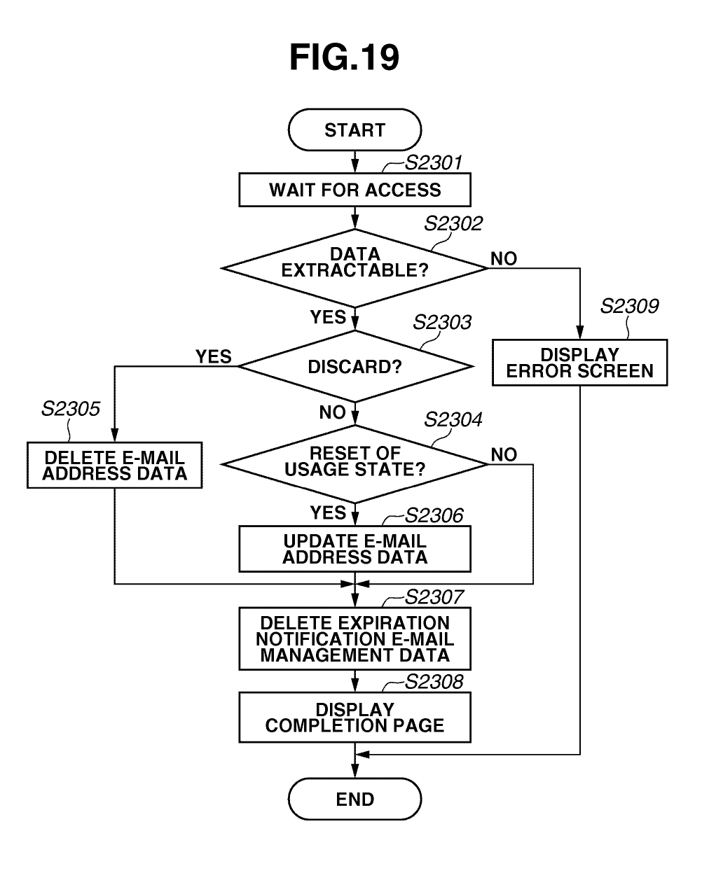

In step S2105, the control unit 121 generates an expiration notification e-mail and transmits the generated expiration notification e-mail to the administrator e-mail address 1205 extracted from the e-mail address management data. Then, the processing returns to step S2102, in which the control unit 121 restarts the above-described processing for the next e-mail address management data. Exemplary processing that can be performed in response to the expiration notification e-mail transmitted in step S2105 is described in detail below with reference to FIGS. 18 and 19.

FIG. 18 illustrates an example of the expiration notification e-mail. The expiration notification e-mail includes descriptions of a target conditional e-mail address 2201, a usage condition 2202, and URLs 2203 to 2205 that are information usable to determine the procedure for the conditional e-mail address. Each of the URLs includes address information (e.g., http://www.print.abc123.com/expired) of the server 120 together with an e-mail ID (e.g., “lbh765 fthja” that follows “id=”) usable to uniquely identify the expiration notification e-mail transmitted by the control unit 121 in step S2105 and a numerical value (e.g., “ex=0”) indicating the procedure for the e-mail address, which are allocated as parameters.

An example of sequential processing that can be performed in response to the expiration notification e-mail (see FIG. 18) transmitted in step S2105 is described in detail below with reference to FIG. 19. The control unit 121 of the server 120 performs the processing of the flowchart illustrated in FIG. 19 when an access to the URL described in the expiration notification e-mail is received.

In step S2301, the control unit 121 waits for an access to the URL described in the suspension notification e-mail from an information terminal owned by the administrator of the image forming apparatus 140.

If there is an access to the URL described in the suspension notification e-mail, the control unit 121 tries to extract, from the e-mail management table 1500, e-mail management data including the e-mail ID 1501 that coincides with the e-mail ID having been set as the URL parameter. Further, if it is determined that the e-mail management data is extractable, then in step S2302, the control unit 121 tries to extract, from the e-mail address management table 1200, e-mail address management data including the e-mail address 1201 that coincides with the e-mail address 1502 of the e-mail management data.

If it is determined that either the e-mail management data or the e-mail address management data is not extractable (No in step S2302), then in step S2309, the control unit 121 transmits an error screen to the information terminal (not illustrated) owned by the administrator of the image forming apparatus 140 and causes a display unit of the information terminal to display the error screen. Then, the control unit 121 terminates the processing of the flowchart illustrated in FIG. 19.

If it is determined that both of the e-mail management data and the e-mail address management data are extractable (Yes in step S2302), then in steps S2303 and S2304, the control unit 121 checks the value representing the procedure for the conditional e-mail address having been set as the URL parameter.

As a check result, if it is determined to discard the e-mail address (Yes in step S2303), the processing of the control unit 121 proceeds to step S2305.

As a check result, if it is determined to reset the usage state of the e-mail address (No in step S2303 and Yes in step S2304), the processing of the control unit 121 proceeds to step S2306.

As a check result, if it is determined that the e-mail address is kept in the suspended state and the value representing the procedure for the conditional e-mail address is invalid (No in step S2303 and No in step S2304), the processing of the control unit 121 proceeds to step S2307.

In step S2305, the control unit 121 deletes the e-mail address management data extracted in step S2302 from the e-mail address management table 1200. The processing to be performed in step S2305 corresponds to updating the usage state 1204 into an “unusable” state.

In step S2306, the control unit 121 updates the e-mail address management table 1200 to reset the usage state 1204 of the e-mail address management data extracted in step S2302 to an initial value.

In step S2307, the control unit 121 deletes the unnecessary expiration notification e-mail management data (i.e., the record 1514 illustrated in FIG. 11). The deletion target is the e-mail management data that has the e-mail ID described in the URL having been accessed in step S2301.

Then, in step S2308, the control unit 121 transmits a completion page that informs the completion of the sequential processing to the information terminal (not illustrated) owned by the administrator of the image forming apparatus 140 and causes the display unit of the information terminal to display the completion page. Then, the control unit 121 terminates the processing of the flowchart illustrated in FIG. 19.

Exemplary processing that relates to the procedure for the suspended e-mail address that has not been used for a predetermined time is described below with reference to FIGS. 20 to 22.

FIG. 20 is a flowchart illustrating processing that can be performed to transmit an e-mail for a disuse notification to the administrator of the image forming apparatus 140 that corresponds to the suspended e-mail address that has not been used for the predetermined time. The sequential processing of the flowchart illustrated in FIG. 20 can be periodically (e.g., once a day) performed by the control unit 121.

The disuse notification is sending an e-mail, which informs that the suspended e-mail address has not been used for a predetermined time (e.g., one month), to the administrator of the image forming apparatus 140 that corresponds to the suspended e-mail address. Further, the disuse notification is sending a notification, which includes information usable to determine the procedure for the suspended e-mail address that has not been used more than the predetermined time, to the administrator of the image forming apparatus 140.

In step S2402, the control unit 121 determines whether any data relating to the suspended e-mail address is present in the e-mail address management table 1200 that manages the e-mail address management data, with reference to the e-mail management table 1500. The determination processing in step S2402 can be realized by checking if the e-mail type 1503 is the suspension notification.

If it is determined that there is not any data (No in step S2402), the control unit 121 terminates the processing of the flowchart illustrated in FIG. 20.

If it is determined that any data is present (Yes in step S2402), then in step S2403, the control unit 121 extracts one of the data and determines whether the e-mail address thereof has not been used for more than a predetermined time (e.g., one month). To check a long term unused state, the control unit 121 can compare the last reception date 1206 of the e-mail address management table 1200 with the system date that can be checked by the control unit 121.

If it is determined that a difference between the last reception date 1206 and the system date is shorter than a predetermined period (No in step S2403 inquiring “Is the e-mail address unused for a long time?”), the processing of the control unit 121 returns to step S2402, in which the control unit 121 restarts the above-described processing for the next data.

If it is determined that the difference between the last reception date 1206 and the system date is equal to or greater than the predetermined period (YES in step S2403 inquiring “Is the e-mail address unused for a long time?”), then in step S2404, the control unit 121 generates disuse notification e-mail management data (see a record 1515 illustrated in FIG. 11).

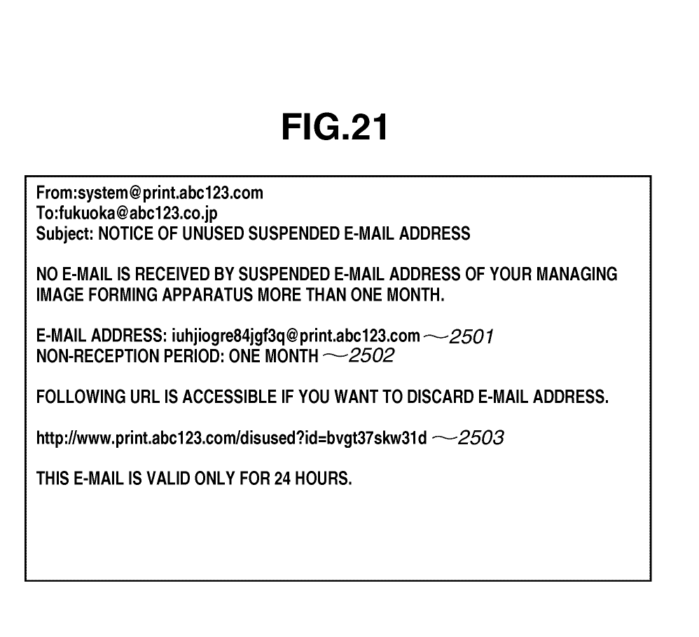

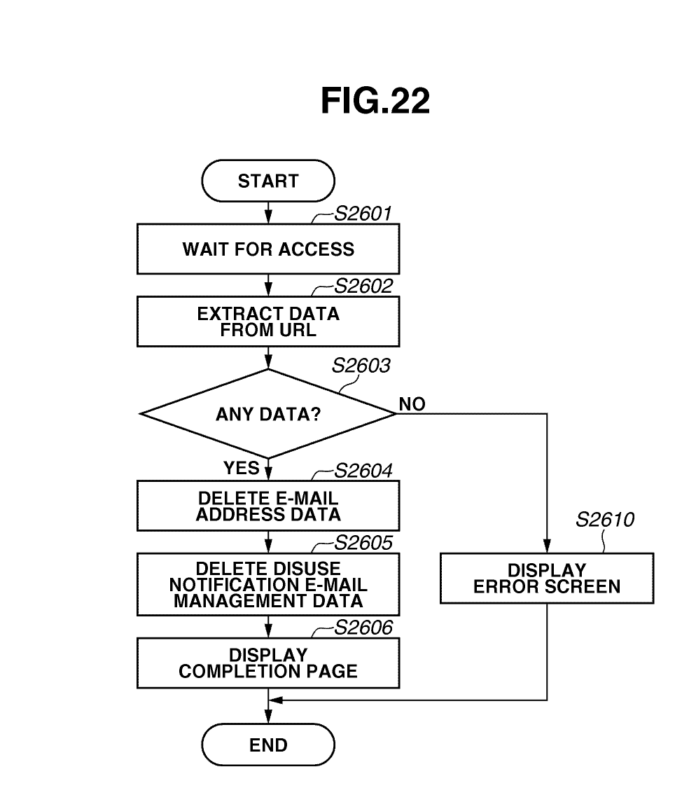

In step S2405, the control unit 121 generates a disuse notification e-mail and transmits the generated disuse notification e-mail to the administrator e-mail address 1205 extracted from the e-mail address management data. Then, the processing returns to step S2402, in which the control unit 121 restarts the above-described processing for the next data. An example of processing that can be performed in response to the disuse notification e-mail transmitted in step S2405 is described in detail below with reference to FIGS. 21 and 22.

FIG. 21 illustrates an example of the disuse notification e-mail. The disuse notification e-mail includes descriptions of a target e-mail address 2501, an e-mail non-reception period 2502 that can be calculated based on the last reception date 1206, and a URL 2503 that is information usable to discard the e-mail address. The URL 2503 includes address information (e.g., http://www.print.abc123.com/disused) of the server 120 together with an e-mail ID (e.g., “bvgt37skw31d” that follows “id=”) usable to uniquely identify the disuse notification e-mail transmitted by the control unit 121 in step S2405, which are allocated as parameters.

An example of sequential processing that can be performed in response to the disuse notification e-mail (see FIG. 21) transmitted in step S2405 (see FIG. 20) is described in detail below with reference to FIG. 22. The control unit 121 of the server 120 performs the processing of the flowchart illustrated in FIG. 22 when an access to the URL described in the disuse notification e-mail is received.

In step S2601, the control unit 121 waits for an access to the URL described in the disuse notification e-mail from the information terminal owned by the administrator of the image forming apparatus 140.

If there is an access to the URL described in the disuse notification e-mail, the control unit 121 tries to extract, from the e-mail management table 1500, e-mail management data including the e-mail ID 1501 that coincides with the e-mail ID having been set as the URL parameter. Further, if it is determined that the e-mail management data is extractable, then in step S2602, the control unit 121 tries to extract, from the e-mail address management table 1200, e-mail address management data including the e-mail address 1201 that coincides with the e-mail address 1502 of the e-mail management data.

If it is determined that either the e-mail management data or the e-mail address management data is not extractable (No in step S2603), then in step S2610, the control unit 121 transmits an error screen to an information terminal (not illustrated) owned by the administrator of the image forming apparatus 140 and causes a display unit of the information terminal to display the error screen. Then, the control unit 121 terminates the processing of the flowchart illustrated in FIG. 22.

If it is determined that both of the e-mail management data and the e-mail address management data are extractable (Yes in step S2603), then in step S2604, the control unit 121 deletes the e-mail address management data extracted in step S2602 from the e-mail address management table 1200.

In step S2605, the control unit 121 deletes the unnecessary disuse notification e-mail management data (i.e., the record 1515 illustrated in FIG. 11). The deletion target is the e-mail management data that has the e-mail ID described in the URL having been accessed in step S2601.

Then, in step S2606, the control unit 121 transmits a completion page that informs the completion of the sequential processing to the information terminal (not illustrated) owned by the administrator of the image forming apparatus 140 and causes the display unit of the information terminal to display the completion page. Then, the control unit 121 terminates the processing of the flowchart illustrated in FIG. 22.

As described above, the procedure described in the present exemplary embodiment resets the usage state of the suspended e-mail address to bring the suspended e-mail address into a reusable state. Thus, the printing system according to the present exemplary embodiment can eliminate a troublesome work in which the administrator of the image forming apparatus 140 informs each user of a conditional e-mail address. Further, the printing system according to the present exemplary embodiment defines an e-mail address, if it does not satisfy the usage condition, as a suspended e-mail address. Therefore, with respect to the content of an e-mail whose destination is set to the suspended e-mail address, it is possible to permit printing of the received e-mail content based on an instruction of the administrator of the image forming apparatus 140. Thus, the administrator can manage the output of a printed product, if necessary.

A printing system according to a third exemplary embodiment is now described below. The printing system according to the present exemplary embodiment is configured to acquire the usage state of the e-mail address or a URL of a management page to change e-mail address settings by transmitting a blank e-mail to the e-mail address issued in step S303 described in the first exemplary embodiment.

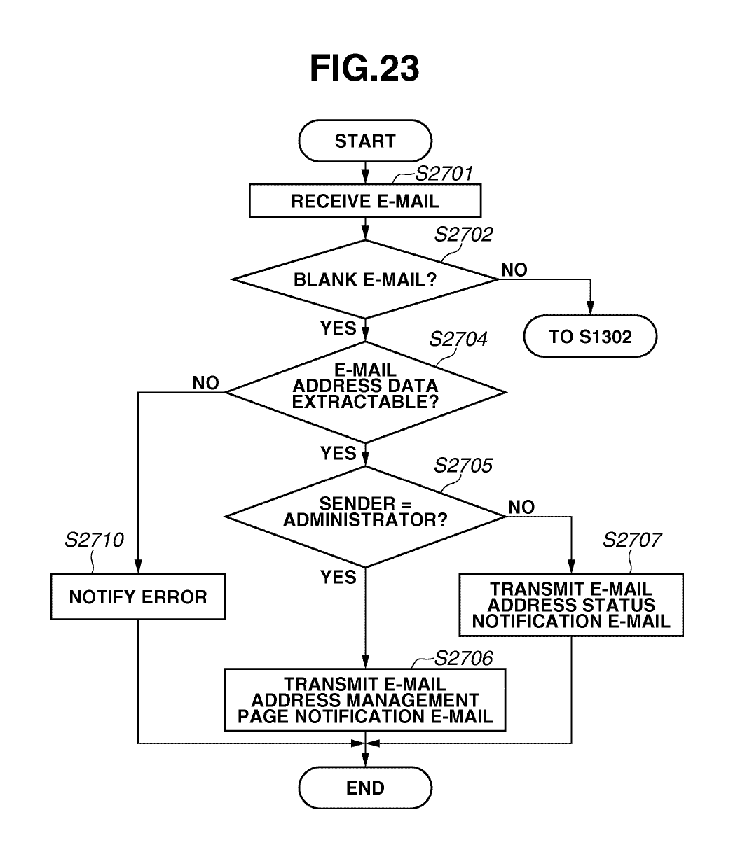

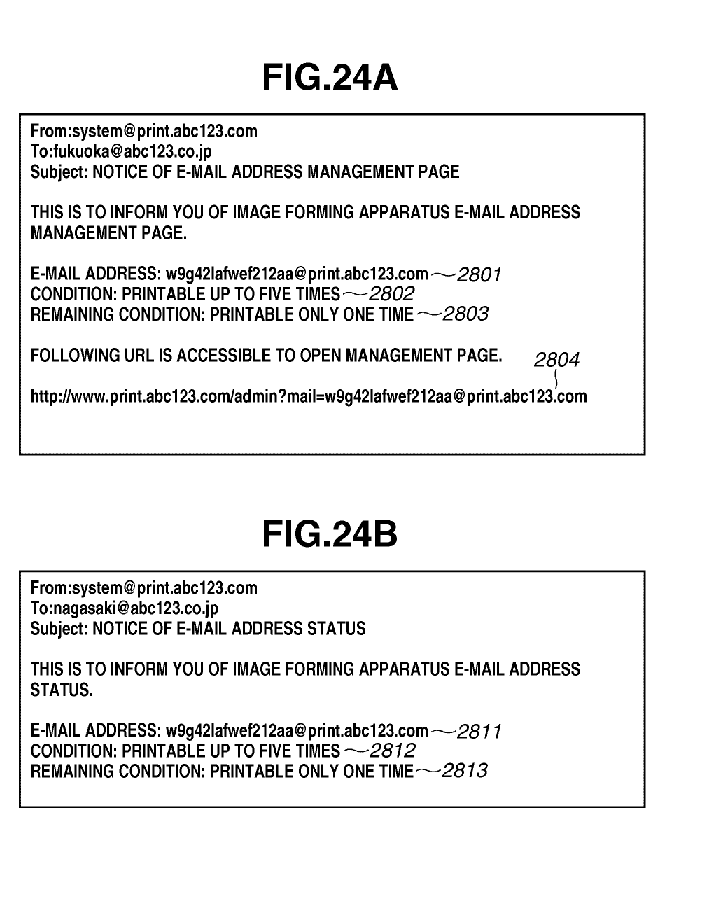

The present exemplary embodiment is to be used with the above-described first exemplary embodiment. Constituent components described in the present exemplary embodiment are similar to those described in the first exemplary embodiment. The present exemplary embodiment is different from the first exemplary embodiment in processing of the mail reception to be performed by the control unit 121 in step S1301 illustrated in FIG. 9. The processing to be performed by the control unit 121 in step S1301 is described in detail below with reference to FIGS. 23, 24A, and 24B.

FIG. 23 is a flowchart illustrating an example of the processing that can be performed by the control unit 121 when the control unit 121 receives a blank e-mail.

In step S2701, the control unit 121 receives an e-mail transmitted from the mobile 110.

In step S2702, the control unit 121 determines whether the received e-mail is a blank e-mail. In the present exemplary embodiment, if the subject and the body of an e-mail are both blank (not entered) and no file is attached, then the e-mail can be defined as a blank e-mail. Alternatively, an e-mail that does not include any attachment file can be defined as a blank e-mail.

If it is determined that the received e-mail is not a blank e-mail (No in step S2702), the processing of the control unit 121 proceeds to step S1302, which was described with reference to the flowchart illustrated in FIG. 9. In this case, the control unit 121 performs the rest of the sequential processing described in FIG. 9.

If it is determined that the received e-mail is a blank e-mail (Yes in step S2702), then in step S2704, the control unit 121 tries to extract, from the e-mail address management table 1200, e-mail address management data including the e-mail address 1201 that coincides with the e-mail address designated in the destination (e.g., the “To” field of the e-mail header) of the received e-mail.

If the e-mail address management table 1200 does not include the e-mail address designated in the destination of the received e-mail, namely, if the designated e-mail address is not extractable (No in step S2704), then in step S2710, the control unit 121 sends an error notification e-mail to the mobile 110.

If the e-mail address management data is extractable from the e-mail address management table 1200 (Yes in Step S2704), then in step S2705, the control unit 121 determines whether the sender e-mail address (e.g., the mail address in the “From” field of the e-mail header) of the e-mail received in step S2701 coincides with the administrator e-mail address 1205.

If it is determined that the sender e-mail address coincides with the administrator e-mail address (Yes in step S2705), then in step S2706, the control unit 121 transmits a notification e-mail of the conditional e-mail address management page to the administrator. With such management page, the administrator (or the user) can change the usage state or the usage condition of the conditional e-mail address.

On the other hand, if it is determined that the sender e-mail address does not coincide with the administrator e-mail address (No in step S2705), then in step S2707, the control unit 121 transmits a notification e-mail of the conditional e-mail address status (e.g., the usage condition and the usage state) to the sender of the e-mail received in step S2701.

FIGS. 24A and 24B illustrate examples of the e-mail that can be transmitted in response to the blank e-mail in the flowchart illustrated in FIG. 23. FIG. 24A illustrates an e-mail directed to the administrator, which can be transmitted in step S2706. The e-mail illustrated in FIG. 24A includes descriptions of a target conditional e-mail address 2801, a usage condition 2802, a remaining usage condition 2803, and a management page URL 2804. The management page URL can include a target e-mail address allocated as a parameter, if it is desired to skip the input of an e-mail address in each access to the URL.

FIG. 24B illustrates an e-mail directed to a general user, which can be transmitted in step S2707. The e-mail illustrated in FIG. 24B includes a description of a target conditional e-mail address 2811, a usage condition 2812, and a remaining usage condition 2813.

As described above, the procedure described in the present exemplary embodiment uses a blank e-mail to acquire the usage state of a conditional e-mail address or to acquire the management page URL to change the conditional e-mail address settings.

In the above-described exemplary embodiments, the e-mail address itself has been described as information that can be used to determine the printability of image data. However, the information to be used to determine the printability of image data is not limited to the e-mail address. For example, identification information (e.g., a file including a description of an arbitrary character string) that can uniquely identify the usage condition and the usage state (described below) is usable as the above-described information, being neither an e-mail address nor image data. In this case, the mobile 110 transmits an e-mail including image data and the identification information to the e-mail address. The server 120 checks the received identification information to determine whether to perform printing of the image data by the image forming apparatus 140 identified by the e-mail address.

In the above-described exemplary embodiments, each of the control units 111, 121, and 141 performs each processing based on a processing execution computer program. However, the claimed invention is not limited to a software configuration. An appropriate hardware circuit is usable to realize the above-described processing performed by each control unit. Further, the claimed invention can be realized by executing the following processing. More specifically, to realize the functions of the above-described exemplary embodiments, the processing includes providing a software program to a system or an apparatus via a network or an appropriate storage medium and causing a computer (or a CPU, a micro-processing unit (MPU), and/or the like) of the system or the apparatus to read the program and execute the processing based on the read program.

Aspects of the claimed invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., a non-transitory computer-readable medium).

While the claimed invention has been described with reference to exemplary embodiments, it is to be understood that the claimed invention is not limited to the disclosed exemplary embodiments. The scope of the following claims is to be accorded the broadest interpretation so as to encompass all modifications, equivalent structures, and functions.

This application claims priority from Japanese Patent Application No. 2011-249859 filed Nov. 15, 2011, which is hereby incorporated by reference herein in its entirety.

What is claimed is:

1. An information processing apparatus having at least one processor that executes a program, the information processing apparatus comprising:
a receiving unit configured to receive an issuance request of information for identifying a printing apparatus configured to print an image;
a processing unit configured to associate the information with the printing apparatus and to issue the information associated with the printing apparatus if the issuance request is received by the receiving unit;
a determining unit configured to receive an image from an external apparatus together with the information issued by the processing unit and to determine, based on the received information, whether the received image is to be printed by the printing apparatus that is identified by the received information; and
a transmitting unit configured to transmit the image received by the determining unit to the printing apparatus identified by the information if the determining unit determines that the image is to be printed by the printing apparatus.

2. The information processing apparatus according to claim 1, wherein the processing unit is configured to associate a condition to be satisfied to print the received image by the printing apparatus identified by the information with a usage state of the information, and
wherein the determining unit is configured to refer to the condition to be satisfied to print the received image by the printing apparatus identified by the received information and the usage state of the information associated with the condition, and is configured to determine that the image is to be printed by the printing apparatus, if the usage state satisfies the condition, and configured not to determine that the image is to be printed by the printing apparatus, if the usage state does not satisfy the condition.

3. The information processing apparatus according to claim 1, further comprising:
a communicating unit configured to transmit selection information, which is to be selected by a user to determine whether the image is to be printed by the printing apparatus, and to receive instruction information that corresponds to the selection information selected based on an instruction from the user, if the determining unit does not determine that the image is to be printed by the printing apparatus,
wherein the transmitting unit is configured to transmit the image to the printing apparatus if the instruction information received by the communicating unit indicates that the image is to be printed by the printing apparatus, and to delete the image without transmitting the image to the printing apparatus if the instruction information received by the communicating unit indicates that the image is not to be printed by the printing apparatus.

4. The information processing apparatus according to claim 1, further comprising:
an updating unit configured to update a usage state of the information issued by the processing unit to a predetermined state based on an instruction from a user.

5. The information processing apparatus according to claim 1, wherein the information includes an e-mail address, and the image is transmitted by an e-mail whose destination is set to the e-mail address.

6. An information processing method comprising:
receiving an issuance request of information for identifying a printing apparatus configured to print an image;
issuing the information to be used in determining whether the image is to be printed by the printing apparatus identified by the information based on the received issuance request;
receiving an image together with the issued information and determining, based on the received information, whether the received image is to be printed by the printing apparatus identified by the received information; and
transmitting the received image to the printing apparatus identified by the information if it is determined that the image is to be printed by the printing apparatus.

7. The information processing method according to claim 6, further comprising:
associating a condition to be satisfied to print the received image by the printing apparatus identified by the information with a usage state of the information,
referring to the condition to be satisfied to print the received image by the printing apparatus identified by the received information and the usage state of the information associated with the condition, and
determining that the image is to be printed by the printing apparatus if the usage state satisfies the condition and not determining that the image is to be printed by the printing apparatus if the usage state does not satisfy the condition.

8. The information processing method according to claim 6, further comprising:
transmitting selection information, which is to be selected by a user to determine whether the image is to be printed by the printing apparatus, if it is not determined that the image is to be printed by the printing apparatus;
receiving instruction information that corresponds to the selection information selected based on an instruction from the user;
transmitting the image to the printing apparatus if the received instruction information indicates that the image is to be printed by the printing apparatus; and
deleting the image without transmitting the image to the printing apparatus if the received instruction information indicates that the image is not to be printed by the printing apparatus.

9. The information processing method according to claim 6, further comprising:
updating a usage state of the issued information to a predetermined state based on an instruction from a user.

10. The information processing method according to claim 6, wherein the information includes an e-mail address, and the image is transmitted by an e-mail whose destination is set to the e-mail address.

11. A non-transitory storage medium storing a computer-readable program that causes at least one computer to execute the information processing method according to claim 6.

12. An information processing apparatus comprising:
a receiving unit configured to receive an issuance request of information for identifying a printing apparatus configured to print an image;
a processing unit configured to issue the information to be used in determining whether the image is to be printed by the printing apparatus identified by the information, based on the issuance request received by the receiving unit;
a determining unit configured to receive an image together with the information issued by the processing unit and to determine, based on the received information, whether the received image is to be printed by the printing apparatus that is identified by the received information; and
a transmitting unit configured to transmit the image received by the determining unit to the printing apparatus identified by the information if the determining unit determines that the image is to be printed by the printing apparatus.
